(19) United States
(12) Patent Application Publication
(10) Pub. No.: US 2012/0012682 A1
(43) Pub. Date: Jan. 19, 2012

(54) Means For Defining A Flow Passage In A Dripper And Method And Apparaturs For Its Implementation

(76) Inventor: Zvika Einav, Kibbutz Gvat (IL)

(21) Appl. No.: 13/202,199

(22) PCT Filed: Feb. 17, 2010
(86) PCT No.: PCT/IL2010/000136

§ 371 Date: Sep. 29, 2011

(30) Foreign Application Priority Data
Feb. 18, 2009 (IL) 197110

(51) Int. Cl. B05B 15/00

(52) U.S. Cl. 239/542; 83/23

(57) ABSTRACT

A dripper unit adapted to be integrally bonded to an internal surface of a conduit. The unit being of the flat “boat-like” type and is made of solely two parts—an elongated body member formed on its one side that is intended to be affixed unto an inner wall of the conduit with an elongated water exit “pool”; and on its opposite side constructed with a throttle means and with a flow passage formed between them; and the second part is means for defining a flow passage between said means and said body. The dripper unit characterized in that the means for defining a flow passage is formed as an elongated flat thin sheet which is adapted to be bonded to the elongated body member while covering and therefore defining underneath, at least a flow-restricting flow path.

### FIELD OF THE INVENTION

The present invention, the subject matter of this application, is found in the field of drip irrigation devices known as drip emitters (herein after: “drippers”) in general, and focuses on the aspects of designing the structure of drippers and the manufacturing modes of drippers' components and their assembly—in particular.

### BACKGROUND OF THE INVENTION

Drippers are essentially used for of agricultural irrigation tasks, and at times for other tasks such as extracting minerals as well as for treating waste water.

Any professional in the drippers' design area knows that a major component in a dripper's design is the throttle means, or—in other words—the means that causes a reduction of the pressure of the liquid (e.g. —water) flowing through the dripper and reducing the flow rate of the water streaming through it. For example—in a dripper serving in agricultural applications, the dripper reduces the water pressure prevailing in the water supply pipes (or other conduits) and diminishes the water's flow rate streaming from it towards the plant or seedling—down to a low level of dripping (drops).

In the recent decades, wide usage was made of a labyrinth—like throttle means built with multi baffles array along its length (but other throttle means with different architecture are also known and in use, for example even just streaming the water along a narrow and elongated groove).

In the case of the aforementioned multi baffles labyrinth structure, optimal design of the baffles array dictates the planning and forming of them in accurate dimensions and sharpened in their ends facing towards the flow passage that—in tandem, provide the labyrinth.

An outstanding characteristic of the throttled dripper means, is expressed in the manner they are formed—namely with a narrow and relatively small flow passage dimensions. Naturally, such a design of the passage increases the sensitivity of the passage to clogs, and the professional that are engaged in developing and designing drippers, are required to meet the challenge of maintaining the flow passages free (i.e., open) and to reducing the risk of their being clogged up.

An additional challenge encountered by the professional that they have to cope with, is the necessity to design the drippers as a low priced, relatively easy to manufacture and to assemble item. In the recent years the drippers' market has become more sophisticated and technologically advanced, generating fierce commercial (marketing) competition that mandates the companies that are active in these markets to maximally reduce their costs while increasing their manufacturing rate.

For example, one of the solutions that have already been adapted, is a process of manufacturing an integral dripper's hose, or—in other words, a hose such that during its continuous manufacturing process (for example—by extrusion) bodies of discrete drippers are affixed to its internal wall surface, one after the other (a technology referred to—at times, as “In Line” drip irrigation pipe).

In the recent decades, integral dripper hoses were very extensively used, in which the inner wall of the hose was exploited also as a kind of a roof that defines the low passage that is formed, as said, in the dripper's throttle means. For example, unto the warm internal wall of the hose undergoing extrusion, there are affixed and soldered by heat, the baffles of the above mentioned dripper's labyrinth, in a manner such that the inner wall serves also as the means that define the relative narrow and small (in its dimensions) flow passage.

In consequence, in an integral drippers hose with a labyrinth affixed to the inner wall of the hose, we spare (“save”) the need of manufacturing and assembling an additional component to the body of the dripper—as there is no need in a specific means for delineating the flow passage, for example “a cover component”, and the internal wall of the hose is what define the flow passage.

Any professional will appreciate that from the time that the necessity for a specific means for delineating the flow passage has been spared, also the width dimensions of the dripper's body might be decreased, in a manner that reduces the (pressure) head losses of the flow inside the hose.

Apparently this provides a response to the challenge of reducing the costs while increasing the manufacturing rate, but actually it is a mixed blessing—

Affixing (flush) an array of accurate baffles as said, accurate in their dimensions and sharpened at their ends, unto the hot and continuously “flowing” inner wall of the hose being extruded, and while having to withstand the challenge of maintaining opened the flow passage and diminishing the risk of its clogging, is not a simple task—definitely not. The tips of the sharpened baffles might be distorted and the still hot and soft material of the hose (in the extrusion process) might slide and partially clog the narrow (and of small dimensions) passage final product as it was obtained from the merger of the wall of the extruded hose with the baffles' array on the body of the dripper.

The plurality of variables as pointed at above, wherein all of them, as said, might influence the quality of the integral drippers, hose with a labyrinth and the repeatability of the performance results obtained for hoses produced even in the same production line, calls for a high level of expertise and accumulated experience, in order to operate this type of a production line—and note that these expertise and experience requirements, naturally raise the costs de novo (anew).

An added disadvantage inherent in the process of affixing the labyrinth to the hose inner wall stems from the obvious requirement dictating top accuracy level at the time of forming the water exit openings at the wall of the hose. Forming the dripper's body with the configuration of a labyrinth along its length, in a manner that the labyrinth sections meant to be affixed flush to the inner wall of the hose, requires that an additional sector would be assigned along the body of the dripper. This additional sector should also be mountable flush to the wall, and would serve as the water's exit “pool”—and into it, and solely into it, the exit opening should be formed in perfect timing (because as said—it is to be remembered that we specified a manufacturing process that is carried out while there is continuous flow and movement of the hose being extruded).

Hence, already in Mehoudar's U.S. Pat. No. 4,210,287 we encounter a suggestion to form a body of an integral dripper in a manner such that the throttle means is formed wherein it is slightly distanced from the internal wall of the hose rather than being affixed to it.

Note that distancing away the throttle means (the labyrinth or the elongated groove) from the wall, enables also forming the water exit “pool’ wherein it would be relatively larger in its dimensions and so that it extends along substantially the full length of the dripper's body (so that there is no need to be bound by the high accuracy requirement nor by the exact timing constraint when forming the water exit opening). It should also appreciate that such large water exit “pool” is mandatory when the opening is to be of the narrow slit type, wherein the closing of the slit is required upon the water pressure decries in order to prevent dirt entry and therefore a relatively long slit is required to be formed precisely opposite the water exit “pool”, and the advantage of large “pool” is evident. In addition distancing away the throttle means thus gain capability to exploit efficiently, substantially the full surface area of the dripper's body for the forming the throttle means.

Delineating a flow passage that is formed in the throttle means, is described in Mehoudar's U.S. Pat. No. 4,210,287 as being executed by a relatively rigid cover member that is secured unto the outer surface of the dripper's body in which the throttle means is formed (elongated groove), (and see there, FIGS. 7 and 8, and in column 7 lines 51 to 68).

Mehoudar's Patent did not describe the relatively rigid cover member (component No. 35 in FIG. 7, ibid), nor how it is secured to the outer surface of the dripper's body in order to define the flow passage.

Due to the absence of details, as well as the fact that commercial launching or marketing of a dripper in accordance with what is described there (in FIGS. 7 and 8, and in column 7 lines 51 to 68) did not materialize, it is logical to deduce that on its face, the quoted subject matter is solely an unproven suggestion of a “relatively rigid cover component” that—as said, does not rest on enabling capability to actually implement the dripper with such “relatively rigid cover component”.

All the more so, any professional would understand that the technological challenge necessitates that some actual usage would be made with means that enable unequivocal delineation of a flow passage in a manner that would prevent leaks and “flow detours” while routing the whole mass of the flow into the passage, so that the flow passing through it would pass along the entire length of the flow passage and solely through it. Simultaneously, the means for defining the flow passage must maintain the flow passage free from clogging due to sliding of material from which the cover means is made of into the narrow flow passage.

Such detailing on the manner of coping with the gliding phenomena of the material from which the cover means is made and how to prevent clogging of the flow passage due to this material is missing also in Cohen's U.S. Pat. No. 5,163,622.

This patent describes, inter alia, (in the configuration illustrated in FIG. 6; see column 5, lines 20 to 53, there) manufacturing drippers by injection on a continuous, elongated flexible element in a plastic strip configuration, that is affixed flush unto the inner wall of the hose being extruded, wherein the other side of each and every dripper is injection molded with an additional layer which closes the open-faces of the labyrinth. But, as said, the patent does not detail how bonding that additional layer would not lead to clogging the flow passages of the throttle means formed in the dripper.

Similarly, Ruskin's et al. U.S. Pat. No. 4,702,787, described sealing the flow-restricting passage by placing a flexible strip over the flow-restricting passage that was formed by injection molding, as part of a molded dripper element formed over a flat base layer of moldable material (that might be form from a number of different materials, see column 7 lines 34 to 46). The flexible strip is heat welded to the molded dripper units by conventional heat seal techniques but the heat seal is not heat sealed to the tops of the baffles, but the bottom of the seal strip rests against the tops of the baffles (see column 6 lines 16 to 35).

Additional technologies for connecting a cover component unto the body component of a dripper are described, inter alia, in the documents of patents that deal with regulating drippers, namely drippers that their throttle means comprise in addition, means for pressure regulating (e.g. —an elastomeric membrane). Any professional would understand that these technologies are not efficient or at least have deficiencies in case they would be implemented for connecting a cover that is meant to serve also as the defining means of a the flow passage in the dripper. So, for example—

in later patents of Mehoudar, e.g., U.S. Pat. No. 6,027,048 and U.S. Pat. No. 6,206,305, a connection of a cover component to a body component of a dripper is described, accomplished by projecting and recessing inter engaging means. Such an array of mechanical connectors (that is heat welded later on to the inner surface of the extruded hose), does indeed contribute to the efficiency of the in advance assemblage of the dripper's components and to securing them one to the other before inserting the assembled dripper into the hose and their soldering in there to a wall, but it is not enough to enable univalent delineation as required for the flow passage (and the flow passage is defined by an elastomeric membrane component).

in DeFrank's publication of patent application US 2005/0284966, a connection of a cover component to a dripper's body component by laser welding process is described. Laser as a welding means is an expensive means and relatively a slow one. Hence, it is not fit for fast and low priced manufacturing as required for drippers' production. This and more, adapting a laser as a means for welding a cover component to a dripper's body component, reduces the variety (number) of suitable materials, because a laser welding is accomplished by heating the contact area of the outer surface of a dripper—after passage of the beam within (inside) the material that therefore, has to be almost inert to the beam transfer through it.

Boswell et al U.S. Pat. No. 6,568,607 describes connection of a hinged cover to a dripper's body using sonic welding (see ibid, FIG. 21 and column 9 line 3). Similarly, Cohen's U.S. Pat. No. 6,250,571, describes a cover ultrasonically welded to a body member of a dripper (see column. 8 lines 2, and 24, and claim 35). Ultrasonic welding required high level of accuracy and geometric compatibility between the welded parts and necessitates expertise in handling the equipment being used.

Hence, due to the disadvantages existing in the prior art as pointed herein above by us, then—

In a time that preceded the invention which is the subject matter of this patent application, a need existed for means suitable to delineates the flow passage in a dripper, that would enable univalent delineation of a flow passage that is formed in a throttle means of a dripper body, in a manner that would prevent leaks and “flow detours”, and while routing the whole mass of the flow into the passage, so that the flow would pass through along the entire length of the flow passage and exclusively solely inside it. However, simultaneously, while maintaining the flow passage free from clogging (due to gliding of material into it during the manufacturing process) and while ensuring the integrity of the baffles' structure that form the labyrinth.

Implementing the means for defining the flow passage in the dripper, is required to be integrateable with the manufacturing process of the drip irrigation line, in a manner that would enable an automated mechanized and continuous manufacturing and at a profitable and competitive price.

In the case of drip irrigation lines of the integral dripper hose type, the means for defining the flow passage, is—in addition, required to enable the forming of the drippers' body while distancing away the throttle means (for example—the labyrinth)—from the wall of the extruded hose (in a manner that allows for including an exit “pool” relatively large in its dimensions, extending along the body of the dripper), and also required is the means for delineating the flow passage, to be relatively narrow in its dimensions, so that installing the means on the body of the integral dripper would not lead to a substantial increase of its dimensions and thus cause—accordingly, an increase of the (pressure) head losses along the length of the hose.

An additional challenge that the designers of a specific means for delineating (defining) the flow passage confronts, is the need to enable an efficient filtering of the water that enters from the pipe (or any other conduit) into the dripper, in order to minimize the phenomena of accumulation of dirt and trash that results in clogging the narrow passages of the throttle means. To this end, use is made of a filtering means (namely a filter) wherein the goal is that the filter shall have as large far as practicable effective size (dimensions) over the filter's surface; while jointly having the water inlet of the filter located as far as practicable from the walls of the pipe (that constitutes a region “rich” in contamination). The means for defining the flow passage is hence required to provide a large and efficient filtering action and in a location that is distanced away from the walls of the pipe as far as practicable.

Another additional challenge is achieving a feasible integration of the means for defining the flow passage also for the so called “integral drippers” of the kind that enables regulation of pressures, and thus—maintaining constant (liquid) flow rate (throughput) from the drippers even when the water pressure in the pipes/conduits varies. Such integral drippers are familiar and well known to provide said pressure regulation, for example—by employing a differential regulation mechanism that is based on an elastomeric membrane that—on its one side, it is exposed to the water pressure prevailing in the pipe, and on its other side is exposed to the reduced (decreased) water pressure as it exists the throttle means or to the decreased water pressure prevailing within the throttle means, in other words, in pressure regulated drippers, we are dealing with an elastomeric membrane that—in accordance with the above cited difference in pressures, it is bendable either within a regulation cavity that is formed in the body of the dripper, towards the exit outlet of the dripper, and away from it, or in case of pressure regulation over the throttle means—towards the flow passage of the throttle means and away from it (or a combination of the latter two), in order to reduce or increase the flow passage—in accordance with the variations of the pressure in the pipe.

### SUMMARY OF THE INVENTION

By one of its aspects, the present invention constitutes a means for defining (or in other words—delineating) a flow passage of a dripper that includes a single or a multi layered sheet (in one preferred embodiment of the invention—a bi-layered sheet, in a second preferred embodiment—a single layered sheet, and in a third preferred embodiment—a single layered sheet with elastomeric characteristics) that is heat solderable unto the outer surface area of the body of the dripper while defining a flow passage between it and the dripper's body.

In an added and different aspect of it, the present invention constitutes a dripper that includes means for defining a flow passage, as said.

In a preferred embodiment, a dripper that includes means for defining a flow passage in accordance with the present invention is characterized in that that the dripper's body member is formed with at least one conformal filtering and draining means, plumbed into and formed closely alongside the throttle means (the water pressure reducing means) that is formed in the dipper's body member, and wherein means for, defining (or in other word—delineating) the flow passage of the dripper (the single or multi layered sheet) is welded on the surface of the body of the dripper component alongside the filtering and draining means, so that from the instant of affixing the body of the dripper unto the inner wall of the pipe, the filtering and draining “means is adapted to receive and filter the water at a distance from the inner wall of the pipe and within the flow of the water in the pipe.

In an additional preferred embodiment of a dripper in accordance with the invention, two filtering and draining means as cited are located along the two sides of the means for delineating the flow means (i.e., on the two sides of the uni-layer or the multi layer sheet).

In yet one more additional preferred embodiment of the invention, the dripper is a pressure regulated dripper and the means for delineating the flow passage, serves in addition also as an elastomeric membrane in the regulation mechanism entity of the dripper.

In yet another and added aspect, the present invention constitutes an apparatus for implementing a means, as said, for defining a flow passage of a dripper, that includes means for positioning a multi or single layered sheet facing the outer surface area of the dripper's body, and affixing it flush to it while defining the flow passage between the sheet and the body of the dripper, and means for subjecting the multi or single layered sheet to heat, that melts the “contact layer” (in case of a multi layered sheet) and solders it to the outer surface area of the dripper's body.

In another and added aspect, the present invention constitutes a method for defining a flow passage of a dripper, that includes the steps of positioning a multi or single layered sheet facing the outer surface area of the dripper's body, and affixing it flush to it while defining the flow passage between the sheet and the body of the dripper, and the stage of subjecting the multi or single layered sheet to heat, that melts the contact layer (in case of a multi layered sheet) and solders it to the outer surface area of the dripper's body, but (in case of a multi layered sheet), does not melt the rest of the layers that are adjacent to the said contact layer.

### BRIEF DESCRIPTION OF THE ACCOMPANYING DRAWINGS

The present invention will be described hereinafter in conjunction with the accompanying figures. Identical components, wherein some of them are presented in the same figure—or in case that a same component appears in several figures, will carry an identical number.

FIG. 1 constitutes a view in perspective (with a partly cut cross section) of an integral flat “boat-like” dripper, in which the means for defining the flow passage in accordance with one embodiment of the invention is implemented.

FIG. 2 constitutes an exploded view of the components of the drip illustrated in FIG. 1.

FIG. 3 constitutes an additional exploded view presentation—from another angle (upside down), of the components of the dripper that are illustrated in FIG. 1.

FIG. 4 constitutes a cross section view of the dripper that is illustrated in FIG. 1, wherein it is included within (inside) a hose that is formed with an hole type water opening.

FIG. 5 constitutes a cross section view (marked a-a in FIG. 4).

FIG. 6 constitutes a cross section view of the dripper illustrated in FIG. 1, wherein it is included within a hose that is formed with a single slit type of a water exit.

FIG. 7 constitutes a cross section view (marked a-a in FIG. 6)

FIG. 8 constitutes a schematic view of an apparatus for implementing means to define the flow passage in accordance with the invention on a body component of an integral flat “boat-like” dripper, of the types illustrated in FIGS. 1 to 7.

FIG. 9 constitutes a view in perspective of an integral flat “boat-like” dripper, in which the means for defining the flow passage in accordance with a second embodiment of the invention is implemented, in combination with a dripper body component which is integrally formed with two conformal filtering and draining means plumbed into and formed closely alongside the dripper's throttle means wherein they are adapted to receive and filter the water flowing at a distance from the inner wall of the pipe.

FIG. 10 constitutes a view in perspective of the body component of the dripper that is illustrated in FIG. 9.

FIG. 11 constitutes a view in perspective (presented from a different angle) of the body component of the dripper that is illustrated in FIG. 9.

FIG. 12 constitutes an illustration of a portion of the body component of the dripper that is illustrated in FIG. 9, wherein it presents the modes of the passage of the water in the dripper.

FIG. 13 constitutes a view in perspective (presented from yet another angle) of the body component of the dripper that is illustrated in FIG. 9.

FIG. 14 constitutes a view in perspective (from one more different angle) of the body component of the dripper that is illustrated in FIG. 9.

FIG. 15 presents the cross section area a-a that is marked in FIG. 10, presents a view in perspective (presented from a different angle) of the body component of the dripper that is illustrated in FIG. 9.

FIG. 16 presents the cross section area a-a that is marked in FIG. 10 wherein it is shown rolled up upwards and presents a view in perspective (from a different angle) of the body component of the dripper that is illustrated in FIG. 9.

FIG. 17 constitutes an exploded view in perspective showing the two components of another example of an integral flat “boat-like” dripper, in which the means for defining the flow passage in accordance with the second embodiment of the invention is implemented in a combination with a body component formed integrally with two conformal filtering and draining means plumbed into and formed closely alongside the dripper's throttle means wherein they are adapted to receive and filter the water flowing at a distance from the inner wall of the pipe.

FIG. 18 constitutes an exploded view in perspective (from another angle) of the two parts dripper that is illustrated in FIG. 17.

FIG. 19 constitutes a view in perspective of the body component of the dripper that is illustrated in FIG. 17.

FIG. 20 constitutes a view in perspective (from another angle) of the body component of the dripper that is illustrated in FIG. 17.

FIG. 21 constitutes an illustration of a portion of the body component of the dripper that is illustrated in FIG. 17, wherein it presents the modes of the passage of the water in the dripper.

FIG. 22 constitutes the cross section area a-a that is marked in FIG. 19, presenting a view in perspective (from a different angle) of the body component of the dripper that is illustrated in FIG. 17.

FIG. 23 constitutes the cross section area a-a that is marked in FIG. 19 wherein it is rolled up upwards and presents a view in perspective (from a different angle) of the body component of the dripper that is illustrated in FIG. 17.

FIG. 24 constitutes the cross section area b-b that is marked in FIG. 19, presenting a view in perspective (from a different angle) of the body component of the dripper that is illustrated in FIG. 17.

FIG. 25 constitutes the cross section area c-c that is marked in FIG. 20, presenting a view in perspective (from a different angle) of the body component of the dripper that is illustrated in FIG. 17.

FIG. 26 constitutes a view in perspective (with a partial cross section) of an integral flat “boat-like” pressure regulated dripper, in which the means for defining the flow passage in accordance with a third embodiment of the invention is implemented, wherein the means for defining the flow passage serves also as elastomeric membrane or providing pressure regulation capabilities (by bending inside a regulating cavity towards the water exiting outlet opening from the dripper and while distancing away from it), while also combined with two conformal filtering and draining means plumbed into and formed closely alongside the dripper's throttle means, that are adapted to receive and filter the water flowing at a distance from the inner wall of the pipe.

FIG. 27 constitutes a view in perspective (with a partial cross section); (from another angle) of the regulated dripper that is illustrated in FIG. 26.

FIG. 28 constitutes a view in perspective (with a partial cross section) of an integral flat “boat-like” pressure regulated dripper, in which the means for defining the flow passage in accordance with a third embodiment of the invention is implemented, wherein said means for defining the flow passage serves also as the elastomeric membrane for providing the pressure regulation capabilities of the dripper (by bending towards the throttle means and by distancing itself from it), while combined with two conformal filtering and draining means plumbed into and formed closely alongside the dripper's throttle means that are adapted to receive and filter the water flowing at a distance from the inner wall of the pipe.

### DETAILED DESCRIPTION OF PREFERRED EMBODIMENT OF THE INVENTION

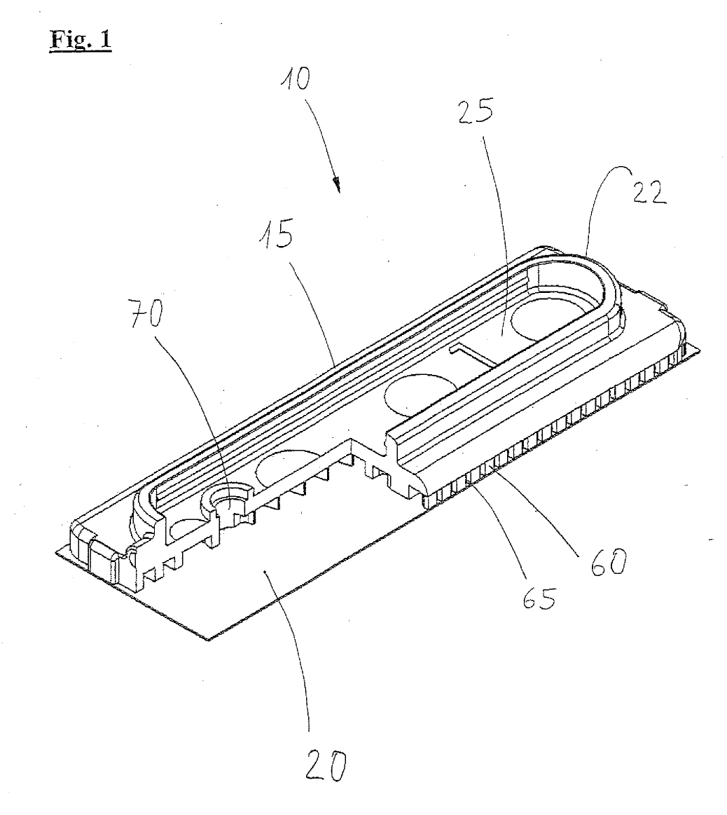

Let's refer to FIGS. 1 to 7. FIG. 1 constitutes a view in perspective (with a partly cut cross section) of an integral flat “boat-like” dripper 10, in which means for defining the flow passage 20 in accordance with the invention is implemented.

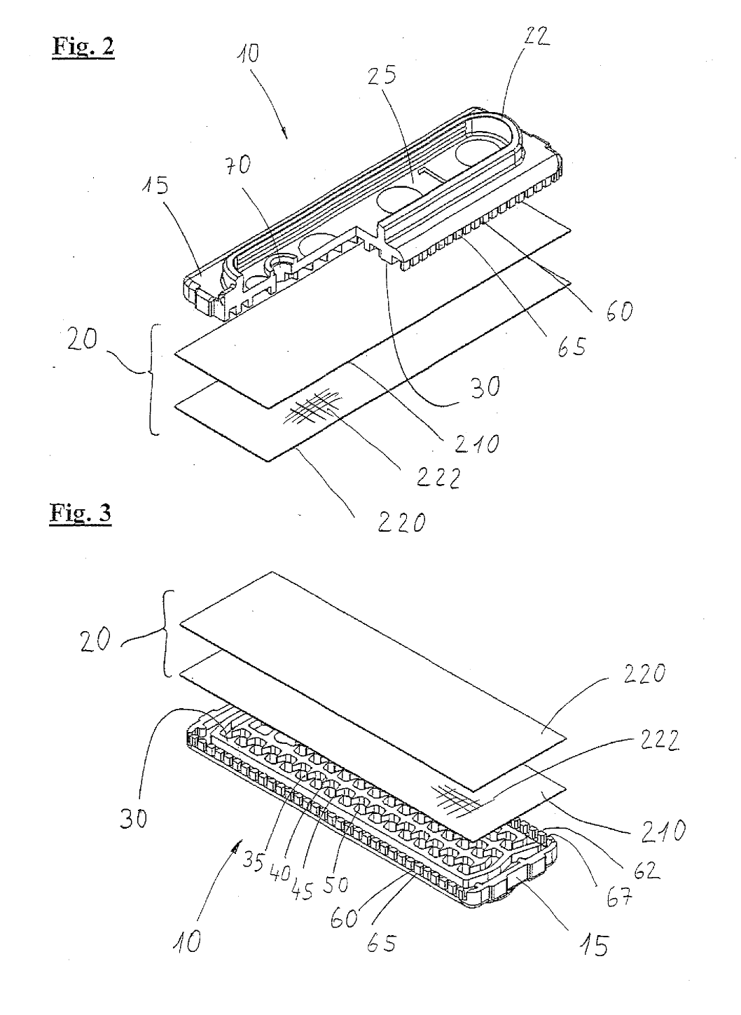

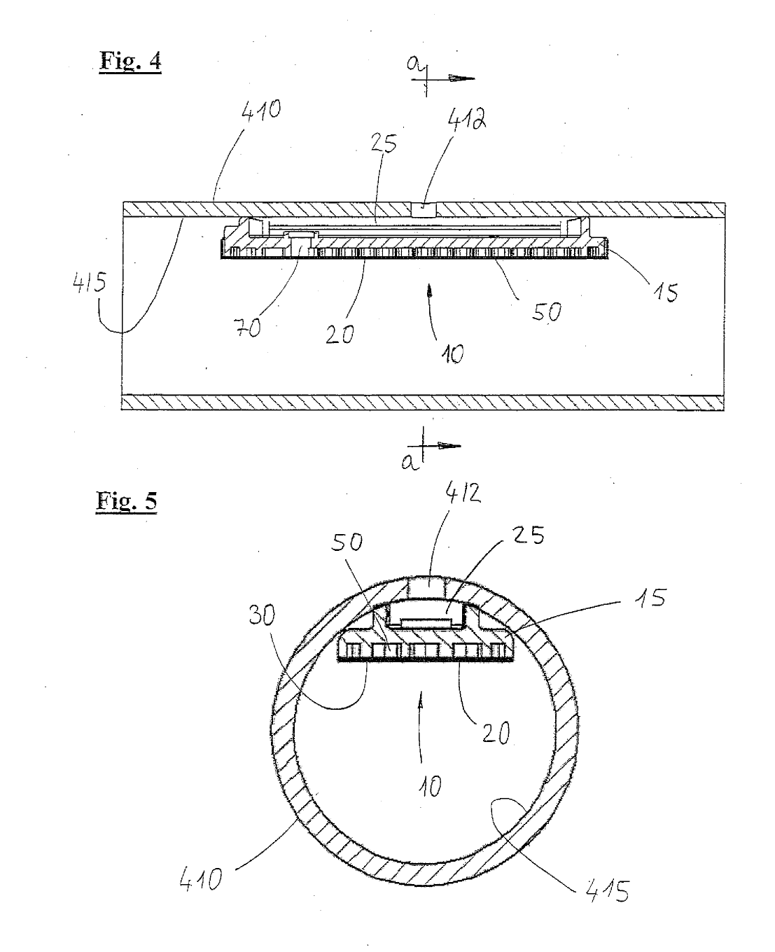

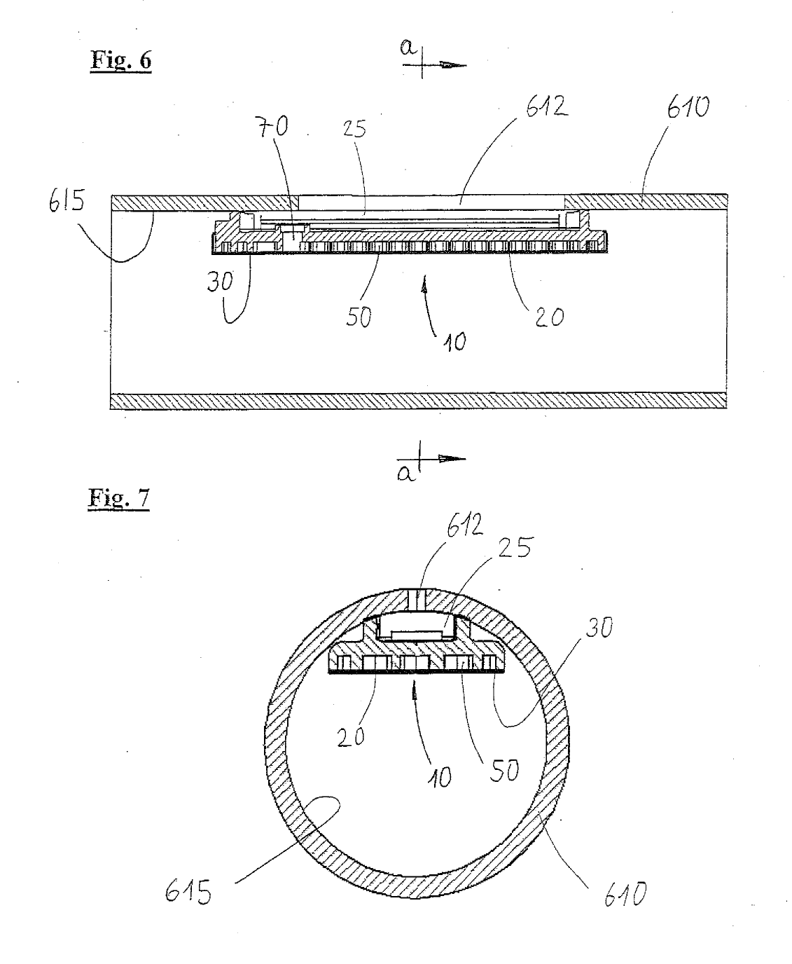

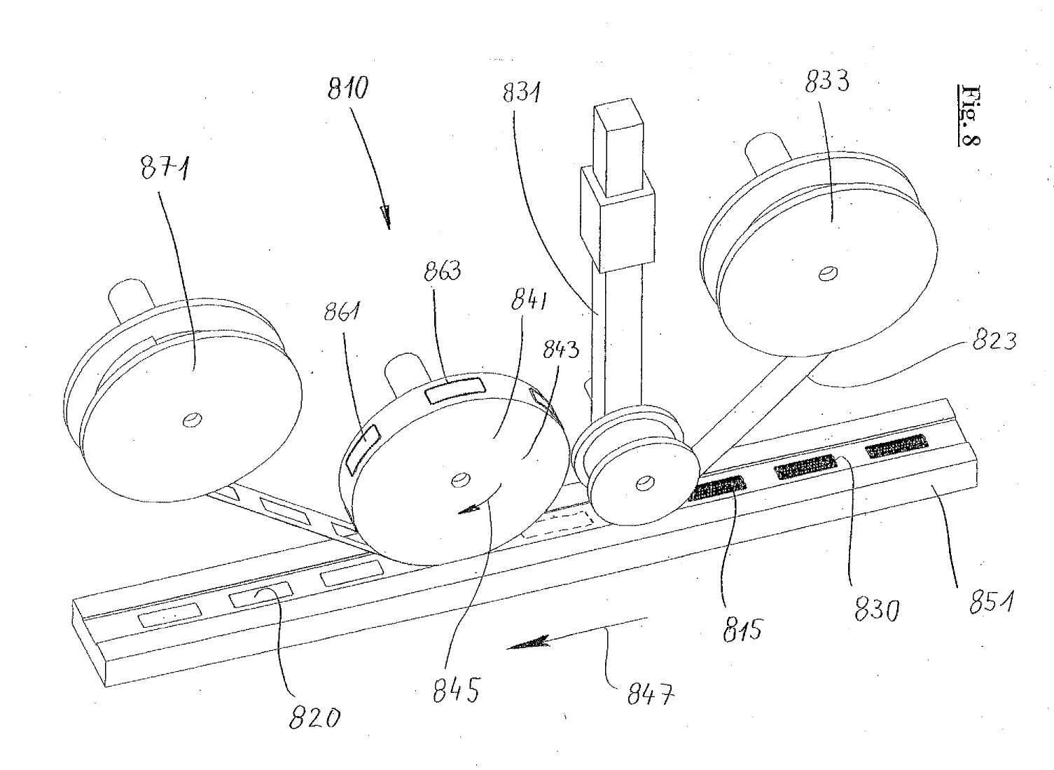

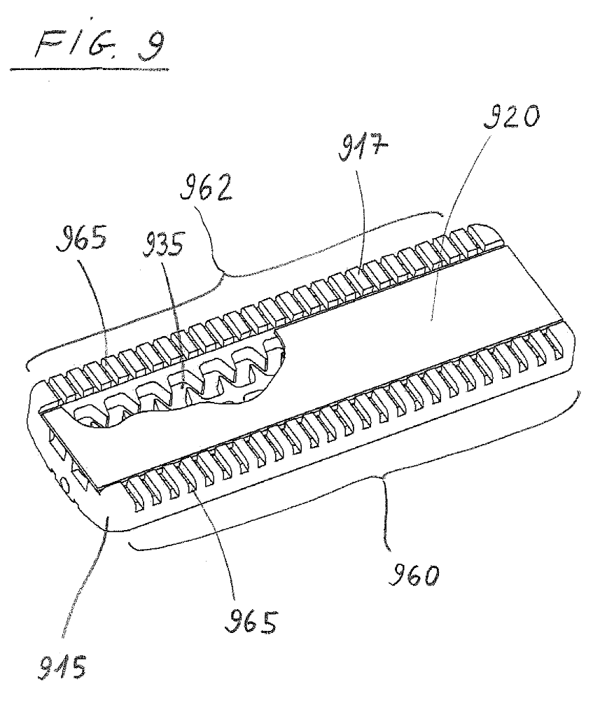

FIG. 2 constitutes an exploded view of the components of dripper 10, and FIG. 3 constitutes an additional exploded view presentation—from another angle (upside down) of the components of dripper 10. FIG. 4 constitutes a cross section view of dripper 10, wherein it is included within (inside) a hose 410 that is formed with an hole type of water opening 412. FIG. 5 constitutes a cross section view (marked a-b in FIG. 4). FIG. 6 constitutes a cross section view of the dripper 10 wherein it is included within a hose 610 that is formed with a single slit type of water exit 612. FIG. 7 constitutes a cross section view (it is marked a-a in FIG. 6).

Any professional experienced in this field would understand that dripper 10 includes a body component 15 that can be manufactured by injection of a polymeric substance into a mold (that is not illustrated).

Upon the outer surface area 22 of component 15 (see FIG. 1), namely the surface area that is intended to be affixed flush to the inner wall 415 of hose 410 (see FIGS. 4 and 5), or alternatively intended to be affixed flush to the inner wall 615 of hose 610 (in the illustrated version—in FIGS. 6 and 7), an elongated water exit “pool” 22 formed.

On the opposing surface area 30 of body component 15, throttle means 35 is formed. In the illustrated example, the throttle means 35 is of the type such as labyrinth 40—a multi baffles array 45 that forms flow passage 50 between them.

In addition, in the illustrated configuration, on the two flanks of body component 15, wherein they extend along its length, there are formed arrays 60 and 62 of alternating passages 65 and 67, respectively. Arrays 60 and 62 are flowable coupled (linked) with one end of flow passage 50 and while delineating by the means for defining flow passage 20, serve as filtering and draining means of the water input from the hose into the throttle means. The other (second) end of flow passage 50 is connected, via opening 70, to the water exit “pool” 25.

A second and last component of dripper 10, is the subject matter of this present patent application—namely the means for defining (or in other word—delineating) the flow passage 20. In accordance with a first embodiment of the invention, the means for delineating the flow passage 20 is a multi layered sheet.

In the illustrated example, we are talking about a bi-layered sheet (see FIGS. 2 and 3)—layer 210 and layer 220. The two layers are fastened flush one to the other (for example by glue 222).

The multi layered sheet is solderable by heat unto the outer surface of the body of the dripper, while delineating the flow passage that lies between it and the body of the dripper. In the illustrated example (and see the figures numbered 1-7)—means for defining flow passage 20 soldered by heat to the outer surface area of the dripper's body 30 of component 15, while delineating the flow passage 50 between it proper and body component 15.

In addition, from the instant of soldering the multi layered sheet to the outer surface area 30, then—in the illustrated configuration, the sheet continues and defines also arrays 60 and 62 of alternating passages 65 and 67, respectively, that as said, while delineating by the means for defining flow passage 20, double as filtering and draining means of the water input from the hose into the water entrance into the throttle means (see FIGS. 1, 2 and 3).

A prominent characteristic of the first embodiment of the means for defining flow passage 20—is, as said, its being multi layered. Restoring to selecting a multi layered means structure, enables an intelligent and rational design of the means in a manner that there exists differences between the fusion (melting) temperatures of the various layers and (also) between their capacitive features and their thermal conductivity values. One would strive to conduct the heat at a relatively high speed, unto as thin as practicable a layer, that would be the one that will be in contact with the outer surface area of the dripper's body (in the illustrated example—layer 210 that gets to contact the outer surface area 30).

Rational selection of the material to be used for the contact layer, enables exciting it by heat until it flows (liquid-wise) by the heat that is transferred swiftly from the rest of the layers, while maintaining the mechanical properties (the relative rigidity) of the other layers whose task is to transfer the heat swiftly (layer 220 in the illustrated example). Simultaneously, care is to be taken—to design also the sorts and properties (e.g. thickness) of the materials of the other layers, so that they would enable, as required, fast heat transfer through them towards the said contact layer which is the one, and solely the one, that has to be excited by the heat swiftly (layer 210 in the illustrated example) without loosing their mechanical properties, as stated.

Any professional would appreciate the fact that a multi layered structure, one that would be endowed with attributes such as fusion (melting) temperature, heat transfer and capacity and preservation of the mechanical properties all different ones—one from the other, would enable—to a high degree, substantial reduction in the quantities of the molten material that might find its way as gliding (running over) from the instant it melted, into the flow passage of the throttle means, and thus causing undesirable clogging.

It is to be remembered that the amount of heat energy that is required to pass through the means for defining the flow passage, should be sufficient for obtaining the sought soldering by heat between it and the outer surface area of the dripper's body, but the throttle means is also formed with a volume of air space (namely the flow passage) that is also subjected to accumulation of excess heat that is translated to molten material that “wanders” (flows) wherein it slides into the flow passage and causes its clogging (and spoils the quality of the dripper).

In consequence, from the time of defining the means for delineating the flow passage, in accordance to the first embodiment of the present invention, as a multi layered means, it is feasible to reduce to a minimum the quantity of material that might be melted over the air space (in a manner that it does not contribute to affixing the means for defining the flow passage to the body component and even more serious than this—rendering the flow passage to be susceptible to the danger of at least partial clogging).

One should also consider the possibility of forming the contact layer of the means for delineating the flow passage with a specific “hot-melt” type of adhesive in accordance with the specific pattern of the throttle means (e.g. —precisely in accordance the multi baffles array pattern); manufacturing the means for delineating the flow passage as a continues thin film; providing such film with a printout (“mask”) in accordance with specific pattern of the throttle means made of different energy absorbable colors (e.g. —dark (heated) and transparent (non-heated) typography in accordance to the labyrinth pattern for laser heating up of the throttle means contact areas more than the film's other areas); and even advance dripper body elements with combination of transparent and darken sections (for laser heating of defined locations).

Defining the means for delineating the flow passage as being multi layered means, also releases us from the limitation s of compatibility of the materials to be selected, as it does exist for an integral dripper and that does mandate, at least apparently, manufacturing a delineating means (a cover) of a relatively large thickness.

Any professional in this field is aware of the limitations applicable to the selection of compatible materials that mandates matching the material of the body of the dripper to the material of the hose being extruded (in order to ensure efficient coupling between them). Mostly, because the hoses are manufactured from polyethylene, then also the body of the integral dripper must be manufactured from this material.

Thus, in this state of affairs, also the means for defining the flow passage (e.g. —the cover), has, as well—to be manufactured from polyethylene or from a similar material (in order that it would be possible to affix it by heat to the dripper's body). The dictation of the polyethylene as the raw material in this case for manufacturing the cover, entails the fact that of accepting also its other properties, such as its mechanical properties that are relatively deficient, in a manner that leads—for example, to imposing the need for increasing the cover thickness in order to prevent undesirable cover's bending.

Needles to say that increasing the cover's thickness directly influences the time that is required for the heat to transfer as it proceeds towards the area of the soldering operation and might influence, as said, also the quantity of material that would slide into the flow passage in the dripper's body.

Any professional would hence appreciate the fact that, in accordance with one embodiment of the invention, designing the means for defining the flow passage as a multi layered means (namely a means that is not homogenous in general and particularly not solely made of polyethylene), enables to circumvent the limitation of compatibility constraint of the materials. In a means for defining the flow passage that is multi layered, only the contact layer is required to be compatible with the kind of material from which the dripper's body is manufactured (as required for soldering them by heat one to the other), and the materials of the other layers might be selected for their contribution to a more efficient heat transfer and to the mechanical properties of the multi layered means.

The means for delineating the flow passage in accordance with this invention might be manufactured in advance, in an extrusion line process of blowing a single or (in accordance with the hereinabove described embodiment), as multi layered films or by lamination of pre-prepared sheets.

A bi-layered sheet, for example—might be manufactured by combining a polyethylene layer (as the contact layer for soldering) with a polyamide layer or an aluminum foil (as the external layer of said bi-layered sheet, that efficiently transfers the heat to the contact layer and excites the contact layer for soldering to the outer surface area of the dripper's body). The total thickness of a bi-layered sheet as said might be from 50 to 150 micron.

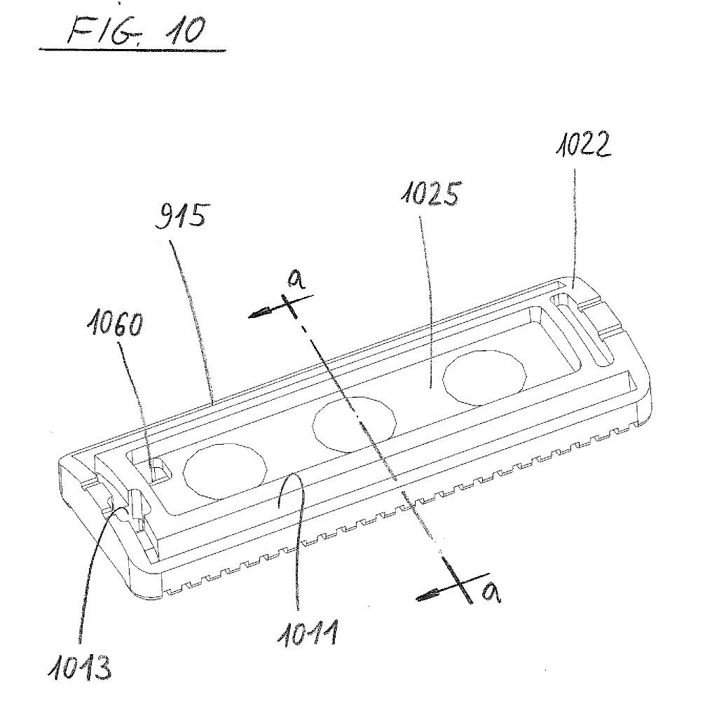

Let's refer to FIG. 8. The figure constitutes a schematic view of apparatus 810 for implementing means to defining flow passage 820 in accordance with the invention, on a body component 815 of an integral flat “boat-like” dripper, (as for example dripper 10 that was described when referring to FIG. 1 to FIG. 7).

Apparatus 810 comprises means 831 for positioning the means for defining the flow passage, or in other words—in accordance with the hereinabove described example, a multi layered sheet 820, facing (towards) the outer surface area 830 of the dripper's body 815 and affixing it flush to it while delineating the flow passage between the multi layered sheet and the body of the dripper.

In the illustrated example, use was made of a multi layered sheet 820 that is pre-prepared (in advance) in a configuration of a roll of a long continuous strip 823, that is being unloaded from cylinder 833. But any professional would understand that the multi layered sheet (or in another embodiment—a single layered sheet), might as well be cut in advance to single portions of the suitable size to cover the outer surface area 830 of the dripper's body, and these portion would be led by a means that will be equivalent to means 831, to face the outer surface area 830 of dripper's body 815 (for example—a manipulator device that ships the pre-prepared multi layered or single layered portions while holding them with vacuum suction means).

Device 810 comprises in addition, means 841 for subjecting the multi layered (or single layered) sheet to heat that melts the contact layer of the multi layered sheet (in case of multi layered sheet), and solders it unto the outer surface area of the dripper's body.

In the illustrated example use is made of a heating unit in a configuration of a rotating wheel 843 that transfers heat and exerts pressure on said surface of the sheet, while advancing in a relatively continuous motion between the wheel turning around its axis (see arrow 845) to the outer surface area of the dripper's body that is driven in a linear motion (see arrow 847) that is substantially equivalent to the circumferential velocity of said of the wheel (in the illustrated example, a linear movement as said of a conveyor means 851 in which several bodies of drippers are assembled).

Any professional would appreciate the fact that in such a dynamic device, the heat transfer and the pressure focus on the radial direction and the tangent to the wheel, in a manner that concentrates the energy into a small area, and hence just a short contact time is required.

Device 810 comprises in addition, means for cutting the edges of the multi layered (or single layered) sheet in accordance with a layout of the required circumference of the dripper's body or any required dimension.

In the illustrated example use is made of shaped cutting knifes 863 that are formed on the circumference of wheel 843. Knifes 863 are suited in their dimensions for cutting the edges of the multi layered (or single layered) sheet around the circumference of each of the drippers' bodies (or in any other required dimension) while they become integrated in a circumferential groove that is formed in conveyer means 851 around each of the dripper bodies that are positioned on it (not illustrated). Any professional would understand that the cutting means might also be other and different means (e.g. —hot wire) and provide for the cutting of the edges of the multi layered (or single layered) sheet in accordance with the required shape and dimension to fit unto the dripper's body member.

In addition, device 810 comprises collecting means 871 that accumulates into it residual of the elongated strip 823 (in the illustrated example by rolling it on a roll)

Any professional in this field would also understand that the means for subjecting the multi (or single) layered sheet to heat that melts the contact layer of the multi (or single) layered sheet and solders it to the outer surface area of the dripper's body, might as well be an ultrasonic soldering system or an array for laser beam soldering.

Any professional in this field would also understand that the three means that we have pointed at earlier (namely, the positioning means, the subjecting to heat means and the cutting means, might be combined into—for example—an installation at an end of a manipulator's arm of a telescopic type means that “imprints” in a linear motion a portion of the multi (or single) layered sheet unto the outer surface area of the dripper's body, concurrently with exerting pressure and heat on the sheet, and continuously goes on and cuts its edges (in accordance with the layout of the dripper's body).

Another potential example—delineating the flow passage while and just after the injection of the dripper's body into the mold, and at a time wherein it is still inside the injection mold, that might be rotatable mold. Thus, after completing the injection forming of the body of the dripper, the mold rotates into a position facing the means for positioning the multi (or single) layered sheet (positioning, subjecting to heat, and cutting that might be performed simultaneously with an additional injection process that is taking place in another section of the rotating mold).

Any professional would appreciate the fact that the proximity of implementing the flow passage defining means to the manufacturing of the body of the dripper that has just been finished and the fact that this operation is being executed within a device that already exists (namely—the injection mold in which the body of the dripper was just molded) instills significant advantages overall—exploiting the vast heat accumulated in the dripper's body, that has just now been crystallized from the flow of a blazing polymer material, for accomplishing the soldering by heat of the means for defining the flow passage into it, and the capability to unload from the injection installation a fully assembled dripper that is ready, for example, to be immediately shipped on to the extrusion production line of the hose into which it is meant to be embedded.

Any professional would also understand that in the manner of implementing means for defining the flow passage in accordance with the invention, there is embodied also a general method for delineating the flow passage in the dripper. In its most general configuration, the method includes the steps of—

Positioning a multi or single layered sheet facing the outer surface area of the dripper's body and affixing it to it while delineating the flow passage between said multi or single layered sheet and the dripper's body. See for example and while referring to the accompanying figures—positioning multi layered sheets 20 and 820 as facing the outer surface area of the dripper's body 30 and 830, respectively, while delineating flow passage 50, between the multi layered sheet and the dripper's body.

An additional stage in the method is the step of subjecting the multi or single layered sheet to heat that melts its contact layer and solders it to the outer surface area of the dripper's body but in case of a multi layered sheet, does not melt the rest (other) layers adjacent to the contact layer. See for example and with referring to the accompanying figures—melting the contact layer 210.

In addition, the method might also include an optional preliminary step, of manufacturing the multi or single layered sheet in the configuration of a rollable elongated strip. See for example and with referring to FIG. 8, the configuration of the multi layered sheet that is illustrated and described there as an elongated strip 823.

In addition, the method might also include another optional preliminary stage, of cutting the edges of the sheet in accordance with the outline of the circumference of the surface area of the dripper's body.

See for example and with referring to FIG. 8, cutting the edges of the sheet after the soldering to the outer surface area of the dripper's body (while leaving behind a configuration of the sheet that is illustrated and described there as an elongated strip, with “windows” that were opened wide in it, from the cutting of the edges of the sheet).

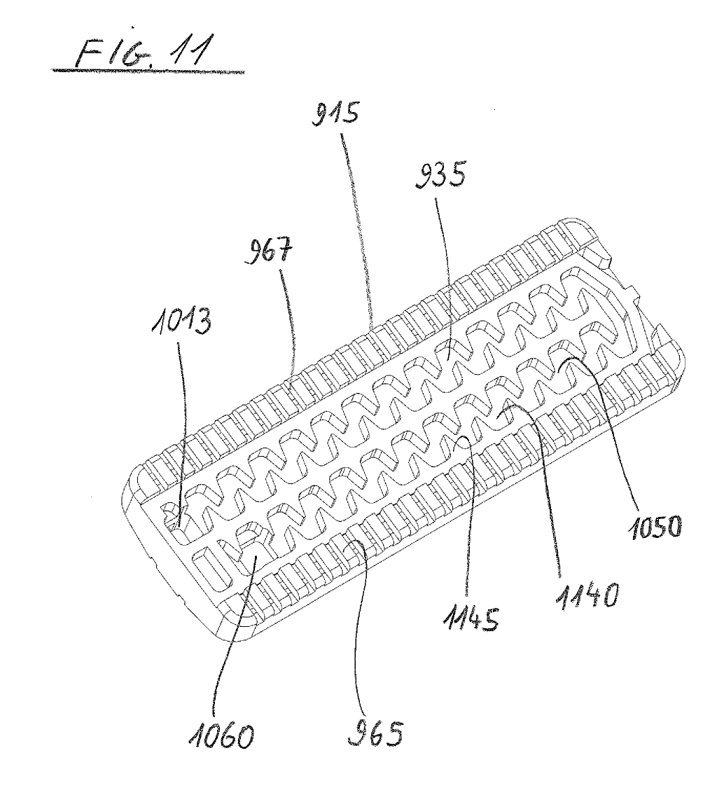

Reference is being made to FIGS. 9 to 16.

FIG. 9 constitutes a view in perspective of an integral flat “boat-like” dripper 910, in which means 920 for defining the flow passage in accordance with a second embodiment of the invention is implemented as it is combined (jointly) with two conformal filtering and draining means (960, 962), plumbed into and formed closely alongside the dripper's throttle means 935. As we shall show later on when referring to FIGS. 9 to 16. In this configuration, there arc two conformal filtering and draining means integrally formed in the dripper's body component and adapted to receive and filter the water at a distance from the inner wall of the water supply pipe (conduit), (that is not illustrated).

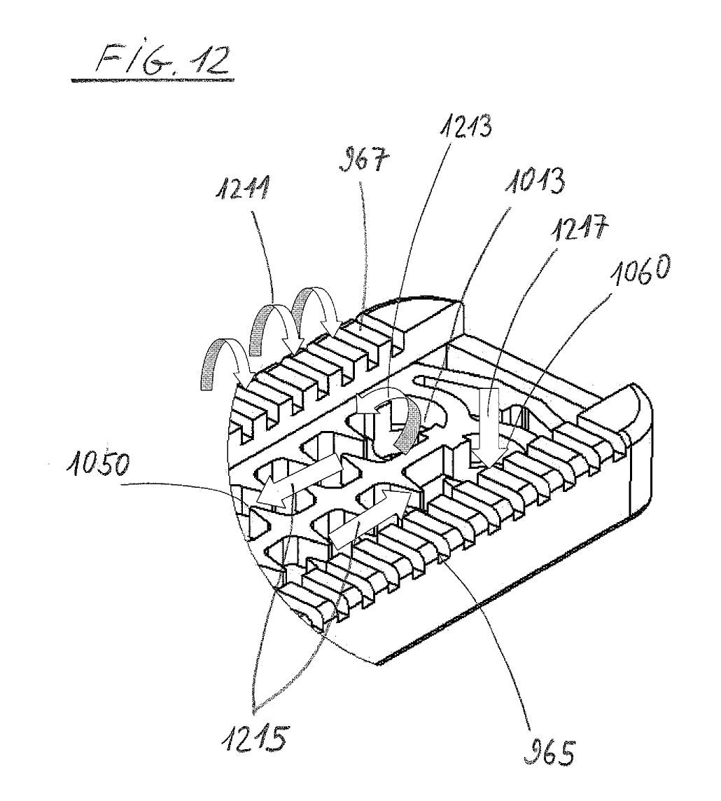

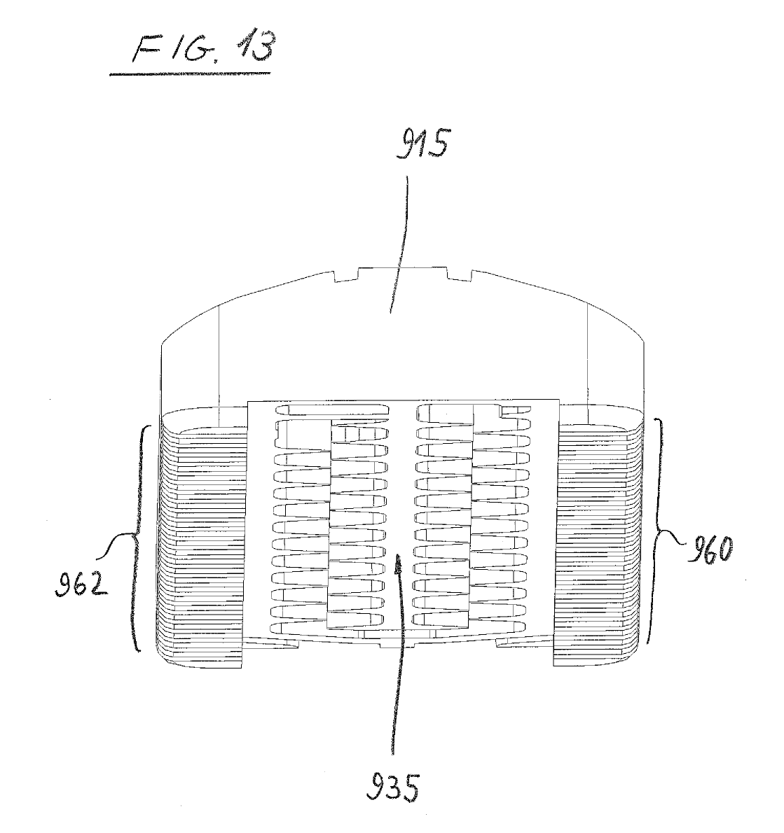

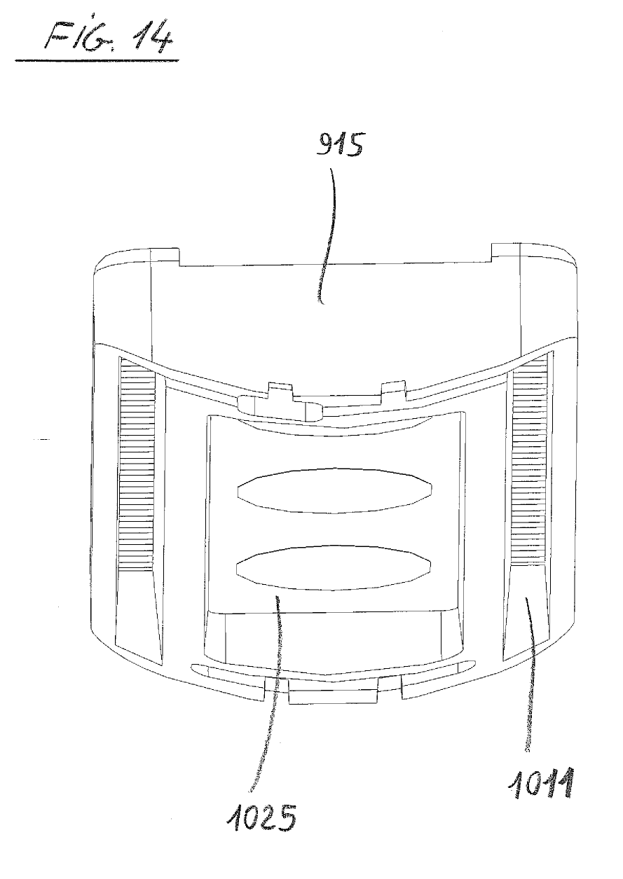

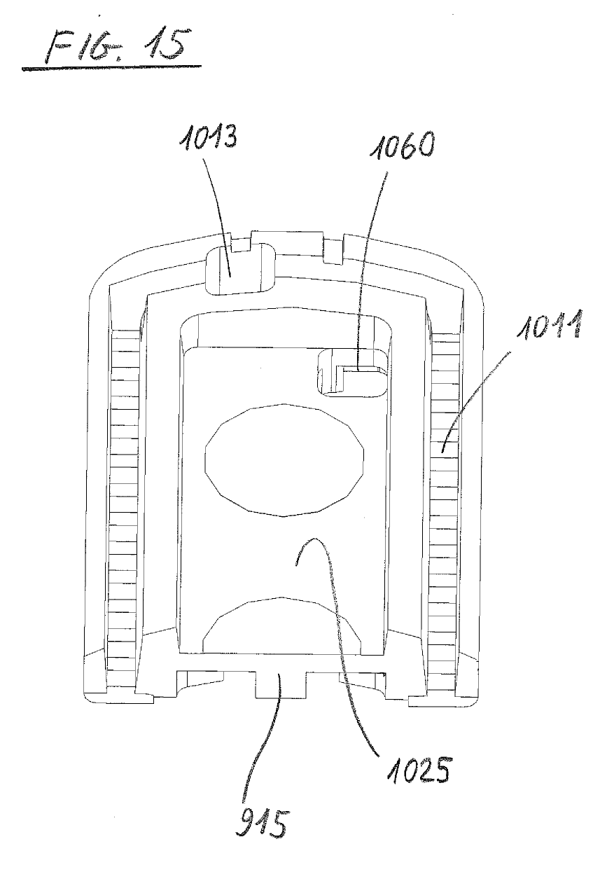

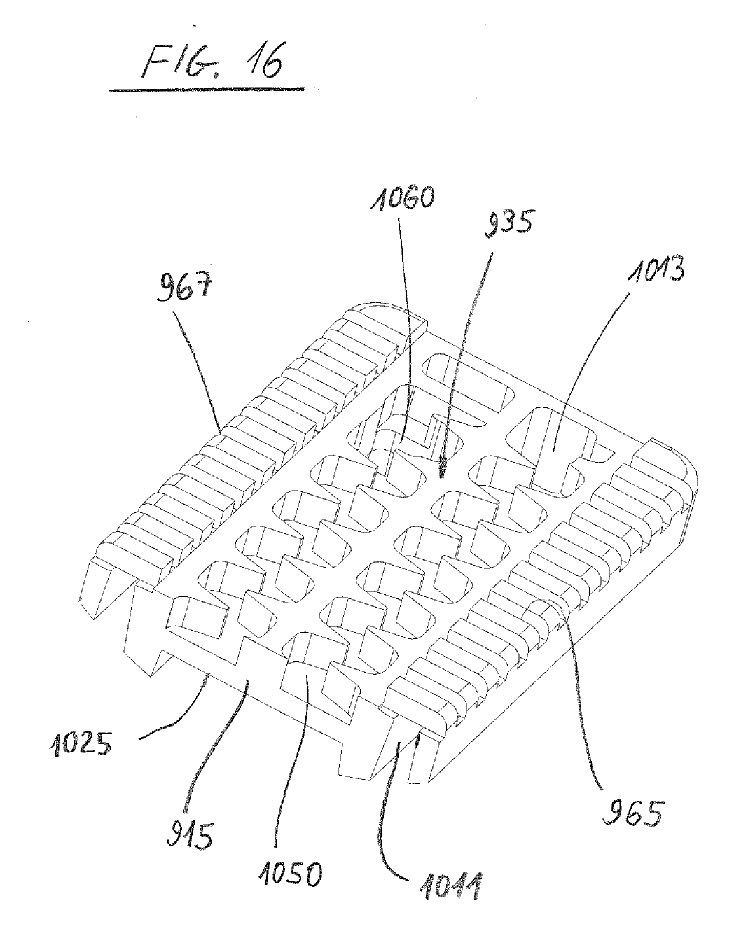

FIG. 10 constitutes a view in perspective of the body component 915 of dripper 910. FIG. 11 constitutes a view in perspective (from a different angle) of the body component 915 of dripper 910. FIG. 12 constitutes an illustration of a sector of said body component 915 of dripper 910, that presents (shows) the mode of the passage of the water in the dripper. FIG. 13 constitutes a view in perspective (presented from yet another angle) of the body component 915 of dripper 910. FIG. 14 constitutes a view in perspective (from another angle) of the body component 915 of dripper 910. FIG. 15 constitutes a cross section area a-a that is marked in FIG. 10 that presents a view in perspective (from a different angle) of the body component 915 of dripper 910. FIG. 16 constitutes the cross section area a-a that is marked in FIG. 10 wherein it is rolled up upwards and presents a view in perspective (from a different angle) of the body component 915 of dripper 910.

In this configuration, means 920 for delineating the flow passage constitutes a single layer (in comparison to the bi-layer sheet that was described above when referring to figures No. 1 to No. 7), but any professional would understand that the sheet might be multi-layered as well.

Any professional would appreciate the fact that sheet 920 is formed as a simple uniform (an entity that does not incorporate nor contain any bores nor holes or specific designs), and actually, as was detailed above when referring to FIGS. 1 to 7, the sheet might be in a configuration of a relatively thin polymeric film.

Sheet 920 of dripper 910 is fitted in its dimensions for being welded along its length to the body component 915 of the dripper, wherein on its flanks (sides) there are two conformal filtering and draining means (960, 962), plumbed into and formed closely alongside the dripper's throttle means 935 as an integral part of body component 915.

This discussed subject is a prominent (remarkable) structural characteristic of dripper 910. As it can be discerned in the figures, the filtering and draining means (960, 962), are formed as an integral part of dripper's body component 915, on its two sides and extend nearly along its entire length.

The filtering and draining means (960, 962), include—each one of them, an array of alternating openings (965 and 967, respectively) that are directed towards the upper surface areas 917 of the body component of the dripper. The arrays (arrangements) of the openings serve, as said, as a filter for the incoming (into the dripper) water flow, and their location on he upper surface areas 917 of the body of the dripper (as distinguished, for example—from directing them towards the flanks (sides) of the dripper, as illustrated in the configuration shown in FIGS. 1 to 7) enables to distance the inlet opening from the flow of the water that is adjacent to the inner wall of the pipe (that is “rich” in contaminants).

The water that enters through the arrays of the openings (see FIG. 12, arrow designated 1211) are drained into ditch (channel) 1011 that is formed on the inner surface areas 1022 of the body component of the dripper (the surface area that is intended for attaching to the inner wall of the pipe). Channel 1011 is formed in a configuration resembling the letter “C”, around the periphery of the body component of the dripper component, wherein it encompasses the exit water “pool” 1025 (see FIG. 10).

Any professional would understand that from the instant of attaching the body of the dripper unto the inner wall of the pipe (or conduit), (that is not illustrated), the inner wall of the pipe would delineate channel 1011 and would turn it to a conduit that drains, as said, and leads the water towards opening 1013 (see FIG. 10).

Opening 1013 leads the water towards the level of the dripper, that from the instant of it being attached flush to the inner wall of the pipe, would be found distanced from this wall—namely towards the level in which the dripper's throttle means 935 is formed (see arrow 1213 in FIG. 12).

Also in this embodiment (as in the previous example described above while refereeing to FIGS. 1-7), the throttle means 935 is in a configuration of a labyrinth 1040 that comprises multi baffles array 1045 that form a relatively narrow flow passage 1050 between them, that extends along substantially the entire length of the dripper's body, while forming a configuration resembling the letter “C” (see in FIG. 11), in a manner that leads the flow of the water in this “C” shaped path while simultaneously substantially reducing the pressure prevailing in the water, towards exit outlet opening 1060 (see FIG. 12, arrows 1215).

Exit outlet opening 1060, leads the water whose prevailing pressure was substantially reduced as said, back to the level of the dripper that from the instant of attaching the body of the dripper flush unto the inner wall of the pipe (or conduit), (not illustrated), would be situated near to this inner wall—namely towards the dripper's level in which the exit “pool” 1025 is formed (see arrow 1217, FIG. 12).

Facing the exit “pool” 1025, and as it was explained above when referring to the configuration of the dripper that was illustrated in FIGS. 1 to 7, drilling of a bore is executed at the wall of the pipe (or conduit), (that is not illustrated), whether in the configuration of a bore or of a slot, one or more, that enables the exit of the water in the form of drops, unto the surface of the area that is intended to be irrigated.

Reference is being made to FIGS. 17 to 25.

FIG. 17 constitutes an exploded view in perspective of the two components of another example of an integral flat “boat-like” dripper 1710, in which the means 1720 for defining the flow passage in accordance with the second embodiment of the invention is implemented, in combination with two conformal filtering and draining means (1760, 1762) plumbed into and formed closely alongside the dripper's throttle means 1735.

As we shall see when referring to FIGS. 17 to 25, in this embodiment too (similarly to the configuration of dripper 910 that was described above when referring to FIGS. 9 to 16), the two conformal filtering and draining means which are plumbed into and formed closely alongside the dripper's throttle means, are adapted to receive and filter the water flowing at a distance from the inner wall of the pipe (or conduit), (that is not illustrated).

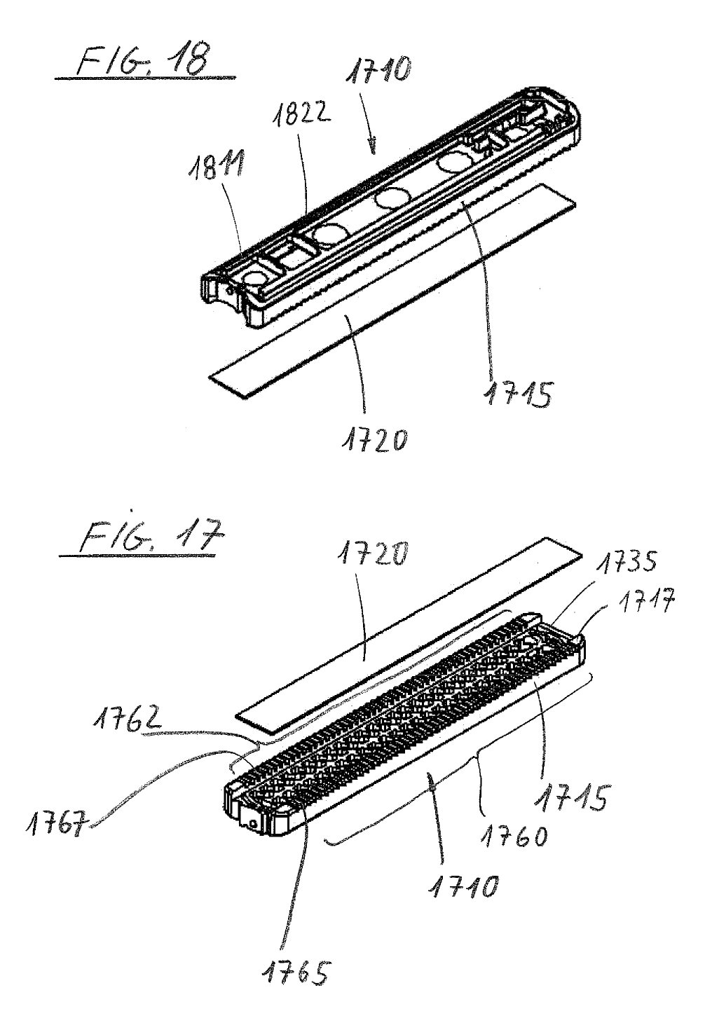

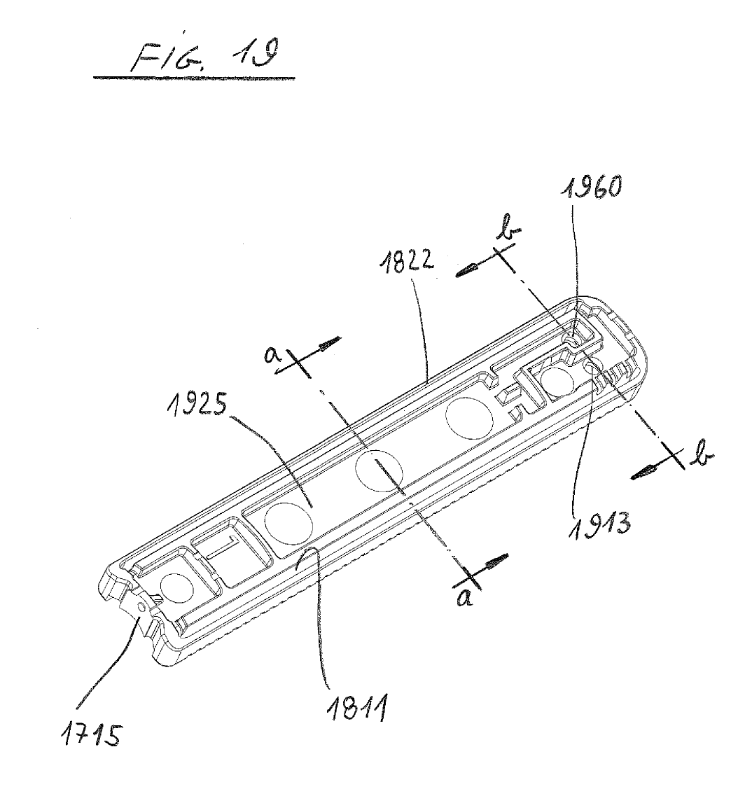

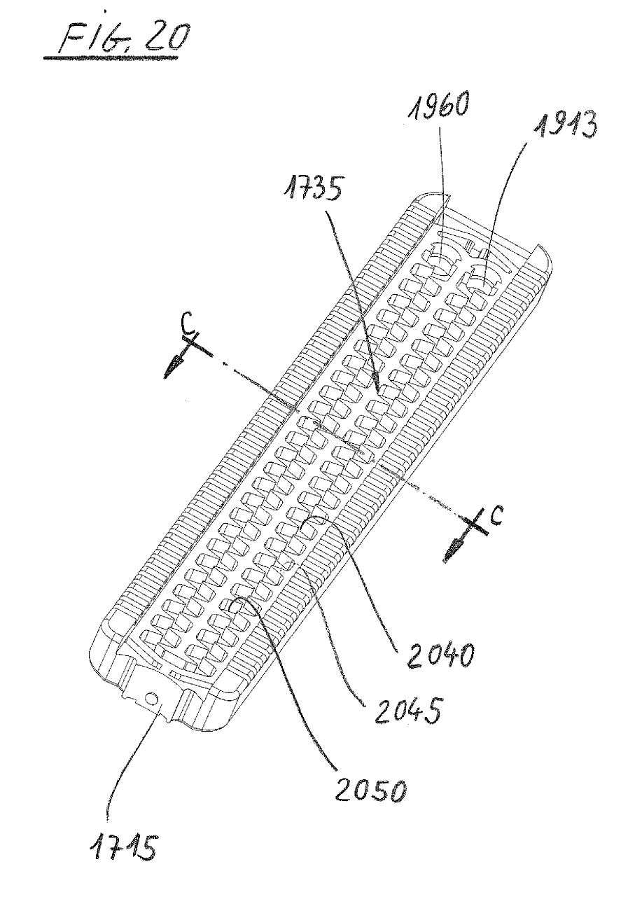

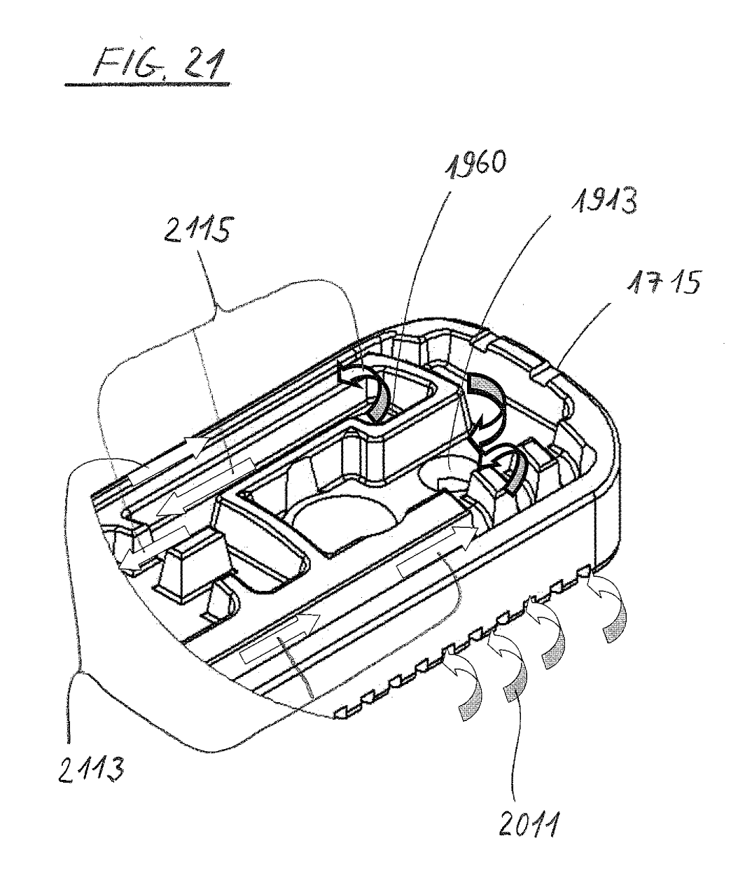

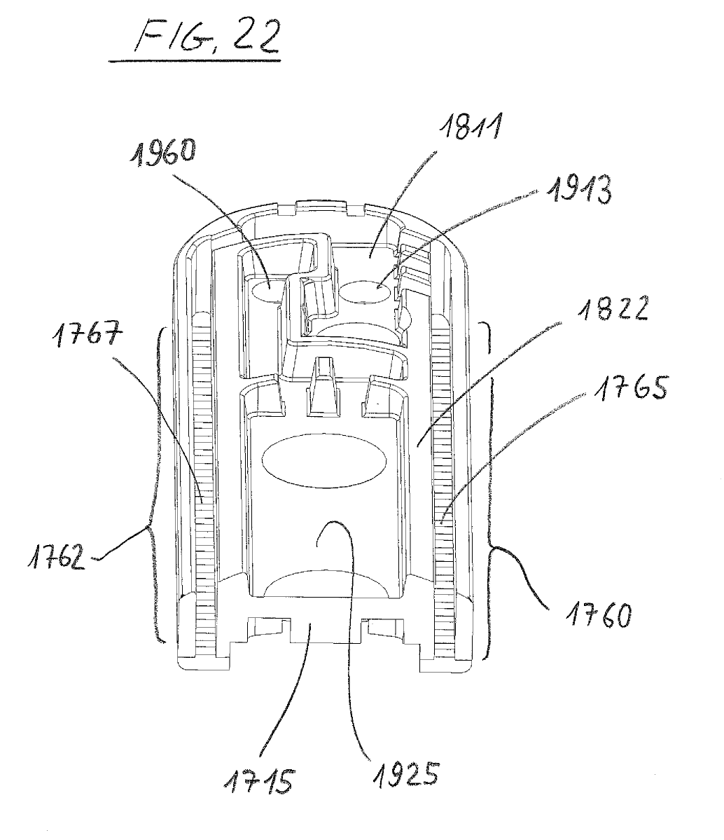

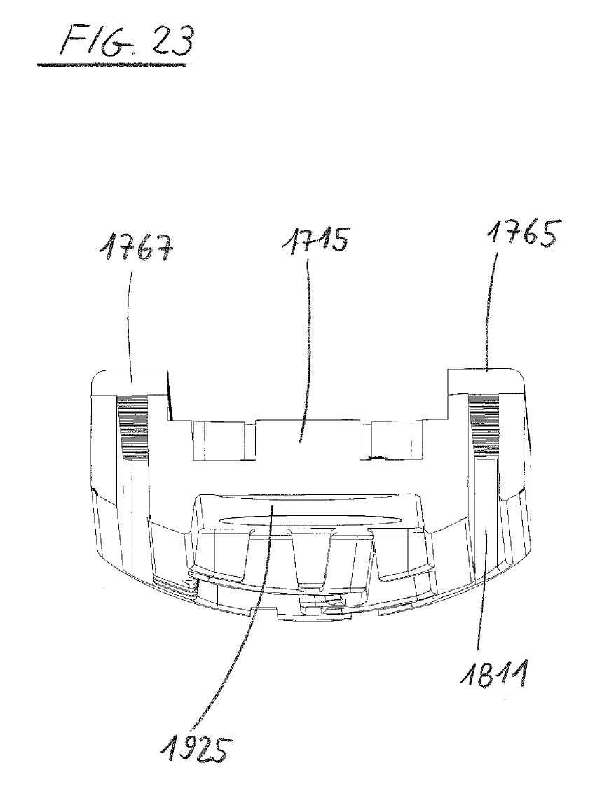

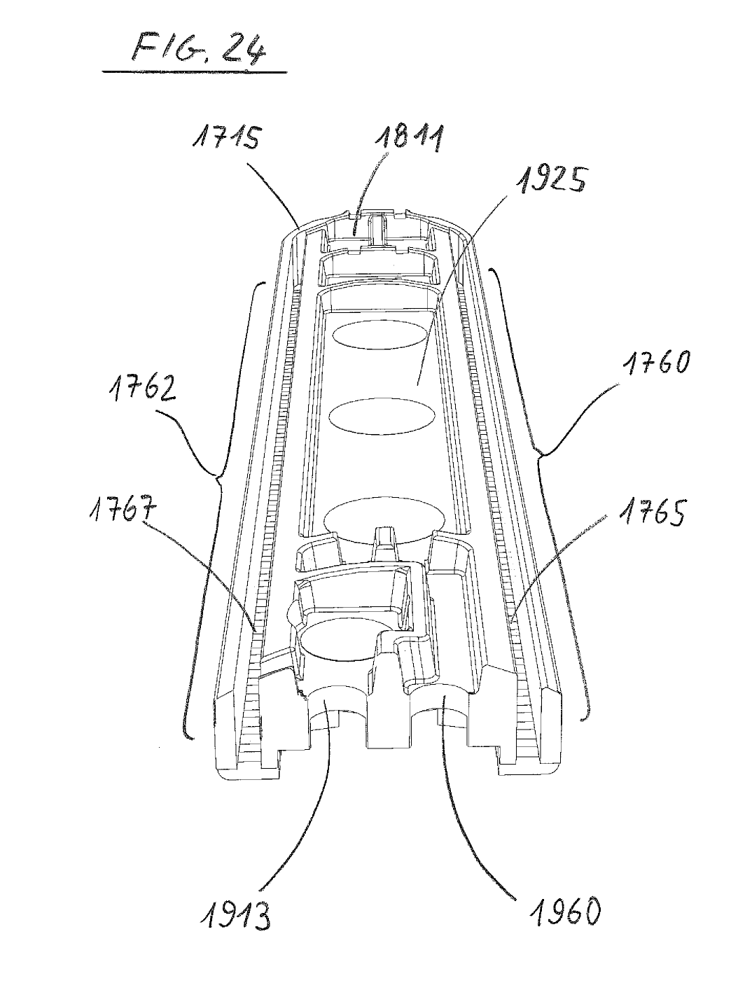

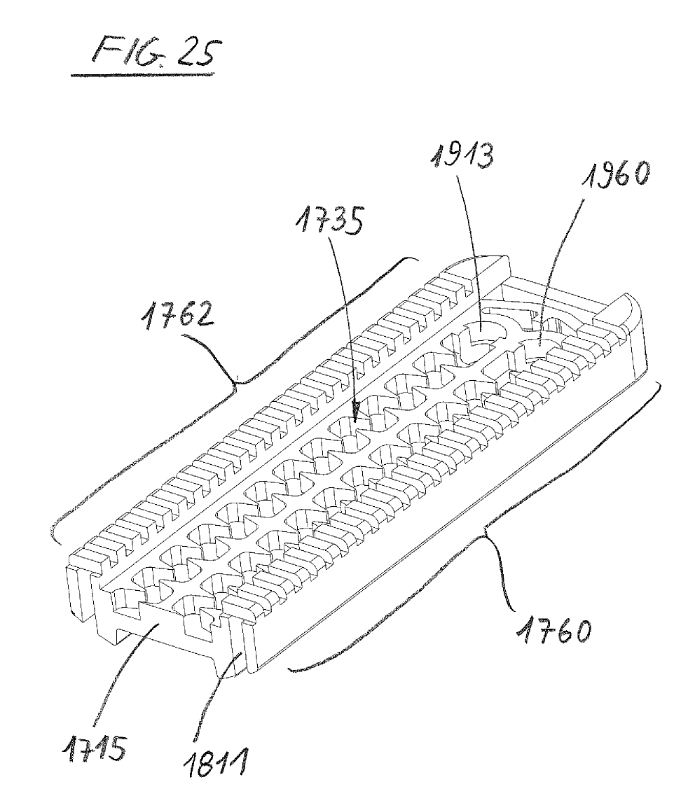

FIG. 18 constitutes an exploded view in perspective (from another angle) of dripper 1710. FIG. 19 constitutes a view in perspective of body component 1715 of dripper 1710. FIG. 20 constitutes a view in perspective (from another angle) of body component 1715 of dripper 1710. FIG. 21 constitutes an illustration section of body component 1715 of dripper 1710, that presents the modes of the passage of the water flow in the dripper, FIG. 22 constitutes the cross section area a-a that is marked in FIG. 19 and presents a view in perspective (from a different angle) of the body 1715 of dripper 1710. FIG. 23 constitutes the cross section area a-a that is marked in FIG. 19 wherein it is rolled up upwards and presents a view in perspective (from a different angle) of body component 1715 of dripper 1710. FIG. 24 constitutes the cross section area b-b that is marked in FIG. 19 and presents a view in perspective (from a different angle) of body component 1715 of dripper 1710. FIG. 25 constitutes the cross section area c-c that is marked in FIG. 20 and that presents a view in perspective (from a different angle) of body component 1715 of dripper 1710.

In this configuration too, as in the case of dripper 910 that was described above when referring to FIGS. 9 to 16, means 1720 for delineating the flow passage space, is a uni-layer sheet (in comparison to the two layers sheet that was described above when referring to the dripper the subject matter of FIGS. 1 to 7), but any professional would understand that the sheet might also be a multi layers type of sheet.

Any professional would also appreciate the fact that sheet 1720 is formed as one simple and integral (verily complete) part in its structure that does not incorporate nor contain any bores nor holes or special designs, and actually, as was detailed above when referring to FIGS. 1 to 7 and also to FIGS. 9 to 16, the sheet might be in a configuration of a relatively thin polymeric film.

In this configuration, as well, similarly to the case of dripper 910 that was described earlier when referring to FIGS. 9 to 16, sheet 1720 is fitted in its dimensions for being welded along its length to the body component 1715 of the dripper, wherein on its two flanks (sides) there are two conformal filtering and draining means (1760, 1762), integrally formed in body component 1715, plumbed into and formed closely alongside the dripper's throttle means 935.

The discussed subject is a prominent structural characteristic of dripper 1710. As it can be discerned in the figures, the filtering and draining means (1760 and 1762), are formed as an integral part of dripper's body component 1715, on its two sides and extend nearly along its entire length.

The filtering and draining means (1760, 1762), include—each one of them, an array of alternating openings (1765 and 1767, respectively) that are directed towards the upper surface areas 1717 of the body component of the dripper. The arrays of the openings serve, as said, as a filter for the incoming (into the dripper) water flow, and their location on the upper surface areas 1717 of the body of the dripper (as distinguished, for example—from directing them towards the flanks (sides) of the dripper, as illustrated in the configuration shown in FIGS. 1 to 7), enables to distance the inlet opening from the flow of the water that is adjacent to the inner wall of the pipe (or conduit), (an adjacent area that accumulate contaminants).

The water that enters through the arrays of openings (see FIG. 21, arrow designated 2111) are drained into ditch (channel) 1811 that is formed on the inner surface areas 1822 of the body of the dripper (the surface area that is intended for attaching it flush to the inner wall of the pipe).

As distinguished (actually different) from dripper 910 that was described above when referring to FIGS. 9 to 16, here we considering a circumferential channel that is formed around the entire circumference of the body component, wherein it encompasses the water exit “pool” 1925 (see in FIG. 19).

Any professional would understand that from the instant of attaching the body of the dripper unto the inner wall of the pipe (or conduit), (that is not illustrated), the inner wall of the pipe would delineate circumferential channel 1811 and would turn it to a conduit that drains, as said, and leads the water towards opening 1913 (see in FIG. 19).

Opening 1913 leads the water towards the level of the dripper, that from the instant of it being attached flush to the inner wall of the pipe, would be found distanced from this wall—namely towards the dripper's level in which the dripper's throttle means 1735 is formed (see arrow 2113 in FIG. 21).

Also in this example, the throttle means 1735 is in a configuration of a labyrinth 2040 that comprises multi baffles array 2045 that form a relatively narrow flow passage 2050 between them, that extends along substantially the entire length of the dripper's body, while forming a configuration resembling of the letter “C” (see in FIG. 20), in a manner that leads the flow of the water of in this “C” shaped path while simultaneously substantially reducing the pressure prevailing in the water, towards exit outlet opening 1960 (see FIG. 21, arrows 2115).

Exit outlet opening 1960, repeats and leads the water whose prevailing pressure was substantially reduced as said, back to the level of the dripper that from the instant of attaching the body of the dripper flush unto the inner wall of the pipe (not illustrated), would be situated near to this inner wall—namely towards the level in which the water exit “pool” 1925 is formed (see arrow 2115, FIG. 21).

Facing the water exit “pool” 1925, and as it was explained above when referring to the configuration of the dripper that was illustrated in FIGS. 1 to 7 and in FIGS. 9 to 16, drilling of a bore is executed at the wall of the pipe (that is not illustrated), whether actually in the configuration of a bore or otherwise of a slot, one or more, that enables the exit of the water in the state of drops, unto the surface of the area that is intended to be irrigated.

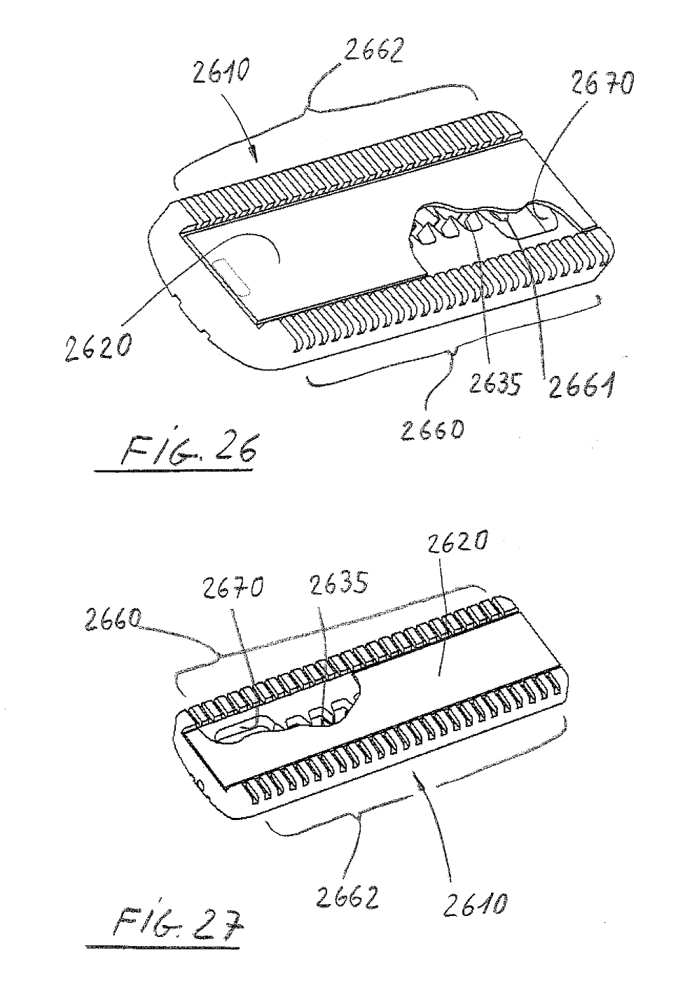

Reference is being made to FIGS. 26 and 27.

FIG. 26 is a view in perspective (with a partial cross section area) of an integral flat “boat-like” pressure regulated dripper 2610, in which the means 2620 for defining the flow passage in accordance with a third embodiment of the invention, is implemented—wherein the means for defining the flow passage serves also as elastomeric membrane, in order to implement a regulation of pressures (by bending inside a regulating cavity 2670 towards the water exiting outlet opening 2661 of the dripper and while distancing away from it), while also jointly combined with two conformal filtering and draining means (2660 and 2662) plumbed into and formed closely alongside the dripper's throttle means 2635 that are adapted to receive and filter the water flowing at a distance from the inner wall of the pipe (that is not illustrated), similarly to the filtering and draining means that were described above when referring to the embodiments depicted in FIGS. 9 to 16 and numbers 17 to 25.

FIG. 27 constitutes a view in perspective (with a partial cross section), from another angle) of regulated dripper 2610.

Any professional would understand that dripper 2610 might be formed in accordance with what was described above when referring to the embodiments of FIGS. 9 to 16 and numbers 17 to 25, wherein the difference is focused on assimilation or implementation of the differential regulation technology on the water exit outlet opening (a technology which is well known and recognized in the field of drippers design). In a structure of a two components dripper (namely, a technology of drippers that comprises solely two components: a body component and a means for delineating a flow passage in accordance with the present invention).

In order to achieve it, in dripper 2610, said means for defining the flow passage is formed as a sheet (uni or multi-layers), endowed with elastomeric properties, and this—at least at the sector that is intended to serve as the elastomeric membrane as said, for the task of regulating pressures (by bending inside a regulating cavity 2670 towards water exiting outlet opening from the dripper 2661 and while distancing itself away from it).

For example, it is possible to manufacture the sheet form Thermo Plastic Elastomer (TPE). This material is sometimes referred to as thermoplastic rubbers, which are a class of copolymers or a physical mix of polymers (usually a plastic and a rubber) that consist of materials with both thermoplastic and elastomeric properties.

Thus, the one and same sheet, would enable to both delineate the flow passage by welding the sheet unto the upper surface area of the throttle means, and jointly to perform the elastomeric bending of the sheet sector that is positioned above the regulating cavity formed in the dripper's body component.

Another possibility is to manufacture in advance the sheet from two suitable components (one from a material endowed with elastomeric properties and the other being relatively rigid).

The body component of the dripper would be formed, with a regulating cavity 2670 as said, —unto which the water is shed on exiting from throttle means 2635 (after the pressure in it was substantially reduced, as said), and wherein at its base (bottom) there is formed an exit opening outlet 2661 towards the water exit “pool” (that is not illustrated), when it is also feasible to form a draining slot in flow communication with exit opening 2661 in order to prevent collapse or “locking” phenomena of the bendable elastomeric sector, and all can be done by technologies researched and well known to any professional in this field.

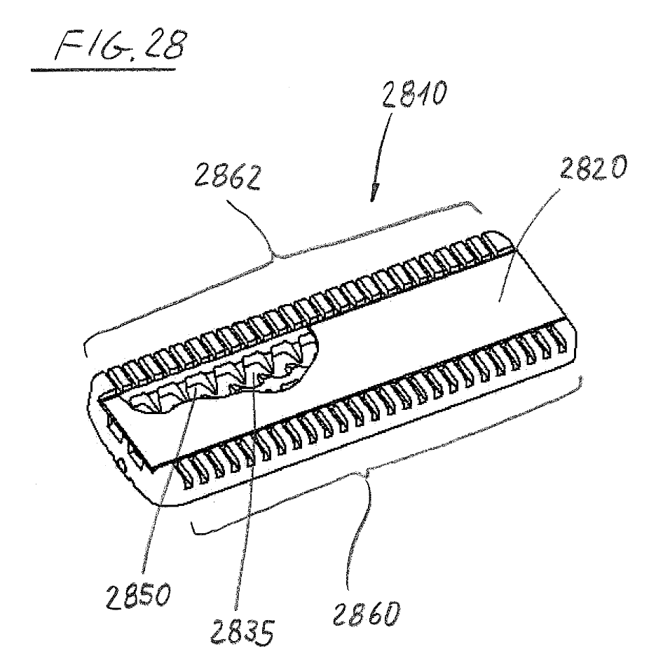

Reference is being made to FIG. 28.

FIG. 28 constitutes a view in perspective (with a partial cross section) of an integral flat “boat-like” pressure regulated dripper 2810, in which the means 2820 for defining the flow passage in accordance with a third embodiment of the invention is implemented, wherein said means for defining the flow passage serves also as elastomeric membrane, to answer the need of implementing a pressure regulation capabilities (by bending towards the throttle means 2835 and by distancing itself away from it)—while jointly combined with two conformal filtering and draining means (2860 and 2862) plumbed into and formed closely alongside the dripper's throttle means 2835 that are adapted to receive and filter the water flowing at a distance from the inner wall of the pipe (that is not illustrated), similarly to the filtering and draining means that were described above when referring to the embodiments of FIGS. 9 to 16 and numbers 17 to 25.

Any professional would understand that dripper 2810 might be formed in accordance with what was described above when referring to the embodiment of FIGS. 9 to 16 and numbers 17 to 25, wherein the difference is focused on assimilation or implementation of the differential regulation technology on the throttle means, for example—the labyrinth means (which is subject to a technology that is well known and recognized in the drippers design discipline), in a structure of a two components dripper (namely, a technology for drippers with solely two components—a body component and a means for delineating a flow passage in accordance with the present invention).

In order to achieve it in dripper 2810, said means for defining the flow passage is formed as a sheet (uni layer or multi layered), endowed with elastomeric properties, for example, made of TPE (as explained earlier) and this—at least at the sector that is intended to serve also as the elastomeric membrane as said, for the task of regulating pressures (by bending towards the narrow water flow passage 2850 that is formed by throttle means 2835 and away from it).

Thus, the same and only single sheet would enable to deal, with both the task of delineating the flow path by welding the sheet to the upper surface area alongside of the throttle means, and as well to execute the elastomeric bending of the sheet sector that is positioned above the flow passage.

An available and suitable technology for implementation in dripper 2810 in order to obtain pressure regulation for said throttle mean 2835 of the multi baffles array labyrinth type of throttle mean (as per the illustrated example), is described in the published international patent application WO9810635—“A Flow-Regulating Element and Drip Irrigation Units Utilizing Same”.

In view of all that was described above, while referring to the accompanying figures, any professional would appreciate the fact that means for defining the flow passage in a dripper in accordance with the invention, will enable univalent delineation of the flow passage that is formed in the throttle means of the dripper's body, in a manner that would prevent leaks and flow bypassing, and while enabling routing the whole flow into the passage so that the flow would pass along the entire length of the flow passage and only in its interior—but, simultaneously, while preserving the flow passage clean and guarded from clogging, and while maintaining the integrity of the baffles that form the labyrinth.

Implementing the means for defining a flow passage in a dripper in accordance with the invention, is easily adaptable and integratable with the known production processes of drip irrigation means, in a manner that would enable the manufacturing of the irrigation means in an automated, mechanized, swift and continuous mode.

Any professional in this field would also understand that the invention might also be implemented in pressure regulated integral drippers as well as also in stickable (On-Line) type of drippers.

Moreover, as described above when referring to FIGS. 26 to 28, using—in accordance with the invention, a thin sheet that might be of a material endowed with elastomeric properties, as a means for delineating a flow passage in a dripper, might lead to substantial savings in the costs of manufacturing pressure regulated integral drippers. This is achieved by avoiding excess procedures and actually cancelling the need of using a structure that employs three components (body component of the dripper, dripper's cover and elastomeric membrane) namely the invention provide for a “two components construction” (the body component of the dripper and a dripper's cover—means for defining flow passage in accordance with the present invention that doubles as the regulating membrane too).

Implementation of means for defining flow passage in accordance with the invention, and this especially in irrigation means of the integral dripping hose type, enables to achieve additional advantages (some synergetic ones), as given below.

The dripper's body that is obtained when implementing usage in accordance with the invention, of a multi or single layered sheet as the means for defining the dripper's flow passage, provides devices with low height (cross section) dimensions—that is relatively small and hence reduces the (pressure) head losses.

An additional advantage is a marked saving in amounts of raw materials when the multi or single layered sheet replaces a dedicated part (a cover) that is produced by injection and that cannot be produced in a thickness that would be equivalent to the thickness of the multi or single layered sheet that replaces it in accordance with the invention (for example, 0.06 to 0.15 mm).

An additional advantage that is derived from using—in accordance with the invention, a relatively thin multi or even single layered sheet, is the possibility to move (slightly) away the throttle means (e.g., the labyrinth) from the hot wall of the extruded hose. In other word, there no longer exists the need to exploit the inner wall of the hose for delineating the flow passage through the throttle (with all the difficulties that this usage generated—consult the “Background of the Invention” chapter).

From the instant that the means for defining the flow passage in accordance with the invention enabled, as said, the distancing away of the throttle means from the wall of the extruded hose, it became feasible to form a relatively large and elongated water exit “pool”—that would extend along substantially the entire length of the dripper's body.

Let's remind and emphasize once again, that a relatively large and elongated water exit “pool” enables to lower the levels of timing and accuracy that are required in order to form the water exit openings from the hose, as well as it enables forming a variety of type of exits (for example—a configuration utilizing an elongated single slit 612—as illustrated in FIG. 6 and FIG. 7), and exploiting fully and efficiently, substantially the entire area of the body of the dripper, inter alia for forming the throttle means (for example—the labyrinth) on it.

An additional advantage that is embodied (thus—included) in drippers manufactured in accordance with the present invention, namely those that were described above when referring to FIGS. 9 to 28, stems from the act of distancing the surface areas of the filter means from the inner wall of the pipe (or in other cases, another type of a conduit) unto which they are intended to be welded. Thus forming the filter means as a means that constitute an integral entity (part) of the body component of the dripper, plumbed into and formed closely alongside the dripper's throttle means, wherein the means for defining the flow passage (the single layer or multi layered sheet) are positioned on its side, enable—as said, distancing also the filter means away from the inner wall of the pipe.

In other words, in accordance with the invention: it is feasible to obtain (when manufacturing) a two components integral dripper (that, as said, might also be a pressure regulating dripper, as can be seen by referring to the FIGS. 26 to 28 described above); with an highly effective filtering means; that is not sensitive to requirements of accuracy (due to the incorporation of a relatively large water exit “pool”; whose throttle means for reducing the water pressure (for example—a labyrinth) is not exposed to risk of contact with the hot wall of the pipe being extruded (unto which the drippers are affixed) due to the subterfuge of it being removed away to the lower level; the means for defining the flow passage is verily a simple component, and relatively low cost (uni-layer or multi layered sheet or film); and that is amenable for mass production, mechanized and also at relatively a low cost.

Thus, using a means for defining the flow passage in accordance with the invention, for a configuration of integral flat “boat-like” drippers, enables obtaining advantages over and beyond the advantage of efficient coupling between this means and the dripper's body—in a continuous and easy process.

Any professional would understand that the present invention was described above only in a way of presenting examples, serving our descriptive needs and those changes or variants in the structure of the means and the system that provides a manufacturing process and a method of defining a flow passage in drippers—which is the subject matter of the present invention, hence they would not be excluded from the framework of the invention.

In other words, it is feasible to implement the invention as it was described above while referring to the accompanying figures, also with introducing changes and additions that would not depart from the constructional characteristics of the invention, characteristics that are claimed herein under.

1. A dripper unit adapted to be integrally bonded to an internal surface of a conduit, said unit being of the flat “boat-like” type and is made of solely two parts—
an elongated body member formed on its one side that is intended to be affixed unto an inner wall of said conduit with an elongated water exit “pool”; and on its opposite side constructed with a throttle means and with a flow passage formed between them; and
means for defining a flow passage between said means and said body; and wherein said dripper is characterized in that—
said means for defining a flow passage is formed as an elongated flat thin sheet which is adapted to be bonded to said elongated body member while covering and therefore defining underneath, at least a flow-restricting flow path.

2. A dripper unit according to claim 1, wherein—
said means for defining a flow passage is solderable by heat unto the outer surface area of said dripper's body.

3. A dripper unit according to claim 1, wherein—
said means for defining a flow passage is a multi layered sheet that comprises—
a contact layer, that is brought unto a soldering contact with the outer surface area of said dripper's body, whose fusion temperature is lower than that of an adjacent layers' fusion temperature.

4. A dripper unit according to claim 1, wherein—
said dripper comprises in addition, at least one conformal filtering and draining means plumbed into and formed closely alongside said throttle means; and—
that from an instant of affixing said surface area unto said inner wall of said conduit; it is adapted for receiving and filtering water at a distant from said inner wall and within flow of water in said conduit; and—
said means for defining a flow passage is adapted to be bonded to said elongated body member alongside said filtering and draining means.

5. A dripper unit according to claim 1, wherein—
said dripper comprises in addition, two conformal filtering and draining means plumbed into and formed closely alongside said throttle means; and
that from an instant of affixing said surface area unto said inner wall of said conduit, it is adapted for receiving and filtering water at a distant from said inner wall and within flow of water in said conduit; and
said means for defining a flow passage is adapted to be bonded to said elongated body member alongside and between said filtering and draining means.

6. A dripper unit according to claim 5, wherein said conformal filtering and draining means comprises
an array of alternating openings that serve for filtering arriving water; and
a channel that is formed at said surface area of said body component that are intended for affixing flush unto said internal wall of said conduit and drains unto it said water from said openings, and that from instant of affixing said dripper unto said inner wall of said conduit; is delineated by said inner wall of said conduit and leads said water unto said throttle means.

7. A dripper unit according to claim 6, wherein
leading said water from said channel towards said throttle means comprises passage of said water from said water exit pool level unto another level wherein there is formed said throttle means.

8. A dripper unit according to claim 6, wherein
said channel is formed around a circumference of said body component of the dripper.

9. A dripper unit according to claim 1, wherein
said dripper is a pressure regulated dripper entity; and
said body component of the dripper is formed with a regulating cavity that is coupled to a flow passage into it from said throttle means and to passage of said water flow from it through water exit outlet opening; and
said means for defining a flow passage comprises a sheet endowed with elastomeric properties that enables its bending within the inside of said regulation cavity towards said water exit outlet opening and its distancing away from it in accordance with prevailing difference of pressures that exist on its two sides.

10. A dripper unit according to claim 1, wherein
said dripper is a pressure regulated dripper entity; and
said means for defining a flow passage constitutes a sheet endowed with elastomeric properties that enables its bending towards said throttle means and distancing from it in accordance with a difference of pressures that prevail on its two sides.

11. A dripper unit according to claim 1, wherein—
said throttle means is a multi baffles labyrinth type of flow-restricting flow path.

12. An apparatus for implementing means for defining a flow passage in a dripper that comprises—
means for positioning a multi or single layered sheet facing the outer surface area of a dripper's body and affixing them flush one to another while delineating said flow passage between said sheet and said dripper's body; and
means for subjecting said sheet to heat that melts a contact layer in said sheet and solders it unto said outer surface area of said dripper's body.

13. An apparatus for implementing means for defining a flow passage in a dripper in accordance with claim No. 12, wherein said apparatus comprises in addition—
means for cutting edges of said sheet in accordance with the layout of the circumference of said dripper's body.

14. An apparatus for implementing means for defining a flow passage in a dripper in accordance with claim No. 12, wherein—
said means for subjecting said sheet to heat, that melts said contact layer of said sheet and solders it unto said outer surface area of said dripper's body, is a heating unit in a configuration of a rotating wheel that transfers heat and exerts pressure on said sheet, while advancing in a relatively continuous motion between said wheel turning around its axis to said outer surface area of said dripper's body that is driven in a linear motion whose velocity substantially equals given circular velocity of said wheel.

15. A method for defining a flow passage in a dripper that comprises the steps of—
positioning a multi or single layered sheet facing the outer surface area of a dripper's body and affixing it flush to it while delineating a flow passage between said sheet to said dripper's body; and
subjecting said sheet to heat that melts a contact layer in said sheet and solders it to said outer surface area of said dripper's body, but does not melt other layers of it that are adjacent to said contact layer.

16. A method for defining a flow passage in a dripper in accordance with claim No. 15.
wherein it comprises in addition a preliminary step of—
manufacturing said sheet in a configuration of an elongated rollable strip.

17. A method for defining a flow passage in a dripper in accordance with claim No. 15, wherein it comprises in addition a step of—
cutting edges of said sheet in accordance with the layout of the circumference of—
said outer surface area of said dripper's body.

18. A conduit integrally formed with at least one dripper unit in accordance with claim 1 attached to its inner wall.
